(19) United States
(12) Patent Application Publication
(10) Pub. No.: US 2006/0144472 A1
(43) Pub. Date: Jul. 6, 2006

(54) Damping and actuating apparatus comprising magnetostrictive material, a vibration dampening device and use of said apparatus

(76) Inventors: Kari Ullakko, Espoo (FI); Juhani Tellinen, Espoo (FI)

Correspondence Address: INTELLECTUAL PROPERTY/PORTFOLIO STRATEGIES, PLLC, 5440 31ST STREET, N.W., WASHINGTON, DC, 20015, US

(21) Appl. No.: 10/547,880

(22) PCT Filed: Mar. 3, 2004
(86) PCT No.: PCT/FI04/00118

§ 371 Date: Nov. 14, 2005

(30) Foreign Application Priority Data
Mar. 3, 2003 (FI) 20030332

(51) Int. Cl. H01F 1/03

(52) U.S. Cl. 148/104

(57) ABSTRACT

The invention relates to devices that produce displacements and/or forces (defined as actuators), when a magnetic field source(s) is (are) placed in such a way that the resulting magnetic field is of suitable strength and orientation in relation to the actuating element made from a Magneto-Mechanical Adaptive (MMA) material, so as to produce the desired displacement of the MMA element; or to devices that dampen mechanical vibrations by absorbing the vibration energy into an MMA element and/or by converting the vibration energy into electric power in the device and/or senses displacement velocity or acceleration. The electric energy can be dissipated to heat or led out from the device. In the latter case, the device works as a power generator. The principle of using the devices as sensors is also described. The MMA material here is defined as a material whose dimensions change when a magnetic field or stress is applied to it, based on twin boundary or austenite-martensite phase boundary motion or magnetostriction.

A damping and actuating apparatus comprising magnetostrictive material, a vibration dampening device and use of said apparatus.

### FIELD OF THE INVENTION

The present invention relates to apparatus that produce motion and/or force, dampens mechanical vibrations, generates electric power, by utilizing twin boundary or austenite-martensite phase boundary motion or magnetostriction of certain materials in the apparatus designs according to the invention.

### BACKGROUND OF THE INVENTION

Certain fast responding actuator materials are used in electromechanics to produce strains and forces. Such materials are piezoelectric ceramics and polymers, electroactive polymers, giant magnetostrictive materials and magnetically controlled shape memory materials. Piezo materials and electroactive polymers are actuated by an electric field. Piezo materials strain less than 0.1%. Electroactive polymers is a new class of actuator materials. They can strain several percent in the electric field. Giant magnetostrictive materials, so as Fe—Dy—Th alloys, develop strains up to 0.2% in a magnetic field. Magnetically controlled shape memory materials develop strains as high as 10% in a magnetic field. In these materials magnetic-field-induced shape change can be expansion in one direction and cortration in the other direction. Shape changes are very fast, e.g., extension of 6% can occur in less than 0.2 ms. The best such kind of materials are Ni—Mn—Ga alloys, whose lattice structure is base centered cubic. One lattice direction, named c-axis, is about 6% shorter than two other axes. C-axis is also the direction of easy magnetization. When a magnetic field is applied on this material, the magnetic field tends to align c-axes along the magnetic field. This happen in such a way that areas, called twin variants, in which c-axis is parallel to the external magnetic field grow and other variants shrink. Ultimately, when the whole volume of the material is changed from one variant state to the other, the dimension of the piece of the material shortens 6% in the field direction. The original dimensions can be restored by applying a perpendicular magnetic field, or by applying a mechanical stress that aligns twin variants in such a way that the short c-axis is aligned along the compresive stress. Magnetically controlled shape memory materials are a new innovation and only a few applications based on them are presented in the public domain.

### SUMMARY OF THE INVENTION

This invention concerns certain construcions of the devices that control mechanical vibrations, generated electric power and produce motion. The vibration control can be passive, semiactive and/or active. The key parts of the devices are active elements, a magnetic circuit containing at least one magnetic field source, such as an electromagnet and/or a permanent bias magnet, and a yoke. The operation of the active element is based on twin boundary or austenite-martensite phase boundary motion or on magnetostriction. The passive vibration control is mainly based on dissipitation of vibration energy in the active element. In semiactive vibration control, the electric power generated by the device when the active element is mechanically deformed is led through, e.g., a shunt resistor. This kind of damping can be controlled by the resistance of the shunt. The active elements can be stiffened by the magnetic field, which can also be used in vibration control. In active vibration control the device is used to produce countervibrations to cancel vibrations. The devices produce fast and precisely controlled motion when the magnetic field is applied to the active element. This invention exhibits a large commercial potential in a variety of fields of use. The devices can be used, e.g., in valves, pumps, injectors, biomedical devices, positioning devices, robots, manipulators, shakers, vibrating devices, Microsystems, fiber optic switches, electrical connectors and circuit breakers.

### BRIEF DESCRIPTION OF THE DRAWINGS

FIG. 1a. Structure of the biased MMA device with a symmetrical construction.

FIG. 1b. Experimental measurement results of the motion of a biased device.

FIG. 1c. Experimental measurement results of the power generation of a biased device.

FIG. 2. Structure of the biased MMA device with a symmetrical constuction and permanent magnet recovery force generation.

FIG. 3. Structure of the biased MMA device with a symmetrical construction and double MMA elements that expand and contract at the same time.

FIG. 4. Structure of the biased MMA device with a symmetrical construction and double MMA elements that expand and contract by turns.

FIG. 5. Structure of the commonly biased MMA device with a symmetrical construction and double MMA elements that expand and contract by turns.

FIG. 6. Structure of the commonly biased MMA device with a symmetrical construction and double MMA elements that expands and contract by turns.

FIG. 7. Structure of the biased MMA device with a symmetrical construction and the permanent magnet location close to the MMA element.

FIG. 8. Structure of the biased MMA device with two coils, the C-core magnetic circuit and the permanent magnet location close to the MMA element.

FIG. 9. Structure of the biased MMA device with four coils, the C-core magnetic circuit and the permanent magnet location close to the MMA element.

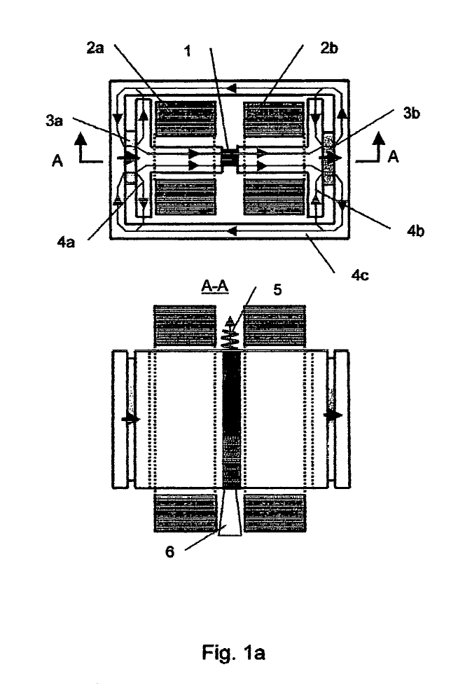

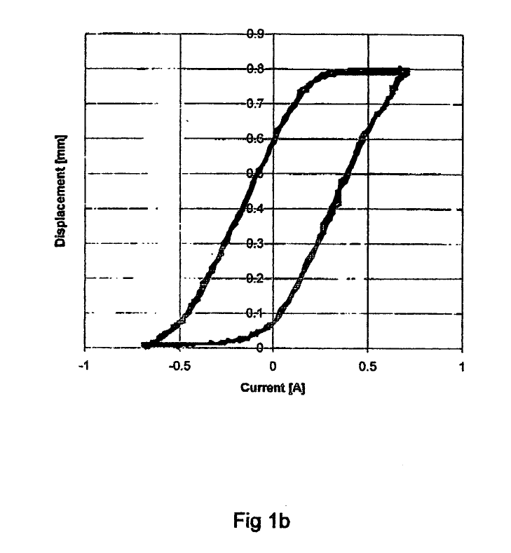

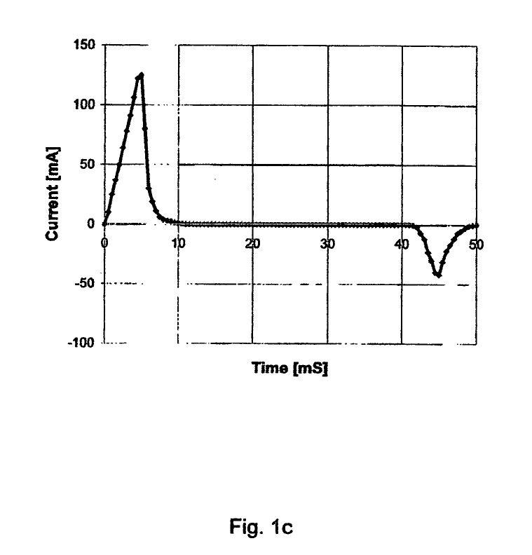

FIG. 1Oa. Structure of the biased MMA device with four coils, the C-core magnetic circuit and two permanent magnet location close to the MMA element.

FIG. 10b. Measurement results of the device.

FIG. 11. Structure of the biased MMA device with two coils, the U-core magnetic circuit and the permanent magnet location close to the MMA element.

FIG. 12. Structure of the biased MMA device with an unsymmetrical construction in which the coil and the permanent magnet are located in the same side of the MMA element.

FIG. 13. Structure of the biased MMA device with an unsymmetrical construction in which the coil and the permanent magnet are located in opposite sides of the MMA element.

FIG. 14. Structure of the biased MMA device with an unsymmetrical construction and double MMA elements that expand and contract at the same time.

FIG. 15. Structure of the biased MMA device with an unsymmetrical construction and double MMA elements that expand and contract by turns.

FIG. 16. Structure of the commonly biased MMA device with an unsymmetrical construstion and double MMA elments that expand and contract by turns.

FIG. 17. Structure of the commonly biased MMA device with double MMA elements that work mechanically in parallel and magnetically in series.

FIG. 18. Structure of the commonly biased MMA device with multi MMA elements that work mechanically in parallel and magnetically in series.

FIG. 19a. Structure of the commonly biased MMA device with double MMA elemnents that work mechanically and magnetically in parallel.

FIG. 19b. Axial-symmetic structure of the commonly biased MMA device with MMA elements that work mechanically and magnetically in parallel.

FIG. 20. Structure of the one module of the biased device in which MMA elements work mechanically in parallel.

FIG. 21. Structure of the biased MMA device.

FIG. 22. Structure of the biased MMA device with double MMA elements that expand and contract by turns to produce reversible rotating motion.

FIG. 23. Structure of the biased MMA device with double MMA elements that expand and contract by turns to produce reversible linear moton of a shaft.

FIG. 24. Structure of the biased MMA device with four MMA elements that expand and contract by turns to produce the reversible linear motion of a shaft.

FIG. 25a. Structure of the biased MMA device with four MMA elements that expand and contract by turns to produce the reversible linear motion of a shaft and improved location of the permanent magnets.

FIG. 25b. Measurement results for the displacement and the coil current of the MMA device.

FIG. 26a. Structure of the MMA device with the symmetrical construction.

FIG. 26b. Structure of the MMA device with the symmetrical construction and the through going shaft.

FIG. 27. Structure of the MMA device with the symmetrical constnrction and the permanent magnet recovering force generation.

FIG. 28. Structure of the MMA device with the symmetrical construction and double MMA elements that expand and contract at the same time.

FIG. 29. Structure of the MMA device with two coils and the C-core magnetic circuit.

FIG. 30. Structure of the MMA device with four coils and the C-core magnetic circuit.

FIG. 31a. Structure of the MMA device with two coils and the U-core magnetic circuit.

FIG. 31b. Structure of the MMA device with two coils and the U-core magnetic circuit.

FIG. 32. Structure of the MMA device with the unsymmetrical construction.

FIG. 33. Structure of the MMA device with the unsymmetrical construction and double MMA elements that expand and contract at the same time.

FIG. 34. Structure of the MMA device with double MMA elements that work mechanically in parallel and magnetically in series.

FIG. 35. Structure of the MMA device with multi MMA elements that work mechanically in parallel and magnetically in series.

FIG. 36a. Structure of the MMA device with double MMA elements that work mecanically and magnetically in parallel.

FIG. 36b. Structure of the MMA device with MMA elements located in circle, that work mechanically and magnetically in parallel.

FIG. 36c. Structure of the MMA device with MMA elements located in circle, that work mechanically and magnetically in parallel and the through going shaft.

FIG. 37. Structure of the one module of the MMA device in which MMA elements work mechanically in parallel.

FIG. 38. Structure of the one module of the MMA device with the MMA elements located in line.

FIG. 39. Structure of the MMA device with double MMA elements that expand and contract by turns to produce the reversible linear motion of a shaft.

FIG. 40. Structure of the MMA device with four MMA elements that expand and contract by turns to produce the reverible linear motion of a shaft.

FIG. 41. Measured strain vs. current relationship of an MMA actuator. The actuator structure was similar to Example 26.

FIG. 42. Measured strain and current of an MMA actuator. The actuator structure was similar to Example 26.

FIG. 43. Measured maximum strain as function of opposing load from the MMA actuator. The actuator structure was similar to Example 36.

FIG. 44. Measured stroke of an MMA actuator in the current-irreversible pulse controlled operation and the current in the coils of the actuator.

FIG. 45. Schematic stress vs. strain state diagram of the MMA material in pulse-controlled operation.

FIG. 46. Measured strokes of an MMA actuator in the current-reversible pulse controlled operation and the current in the coils of the actuator.

FIG. 47. Mechanical hysteresis loop of the MMA material.

FIG. 47a. Basic structure of the MMA device with the round MMA elements and in which two orthogonal fields (x- and y-directed) are produced by two orthogonal coil systems that works alternatively.

FIG. 47b. Basic structure of the MMA device with the rectangular MMA elements and in which two orthogonal fields (x- and y-directed) are produced by two orthogonal coil systems that works alternatively.

FIG. 48a. Basic structure of the device with the round MMA elements and in which two orthogonal fields are produced by two orthogonal coil systems that works at the same time.

FIG. 48b. Basic structure of the device with the rectangular MMA elements and in which two orthogonal fields are produced by two orthogonal coil systems that works at the same time.

FIG. 49a. Structure of the device with the round MMA elements and in which two orthogonal fields are produced by coil systems and permanent magnets.

FIG. 49b. Structure of the device with the rectangular MMA elements and in which two orthogonal fields are produced by coil systems and permanent magnets.

FIG. 50a. Magnetic field pattern in the MMA device at the positive current and negative in the coils.

FIG. 50b. Magnetic field pattern in the MMA device at the negative current in the coils.

FIG. 51. Mechanical hysteresis loop of the MMA material.

FIG. 52. Vibration damping device. The magnetic circuit 4 can also be axial symmetric.

FIG. 53a. Bending MMA elements. MMA element is denoted by 1 and the base material is denoted by 2.

FIG. 53b. A bending MMA element, in which Ni—Mn—Ga film 1 is on a substrate 2. The crystallographic axes of the Ni—Mn—Ga are oriented in such a way that a-axis is along the surface and c-axis is perpendicular to the surface. The directions of the magnetic field are H1 and H2.

### DETAILED DESCRIPTION OF THE INVENTION

The invention relates to devices that produce displacements and/or forces (defined as actuators), when a magnetic field source(s) is (are) placed in such a way that the resulting magnetic field is of suitable strength and orientation in relation to the actuating or active element made from a Magneto-Mechanical Adaptive (MMA) material, so as to produce the desired displacement of the MMA element; or to devices that dampen or control mechanical vibrations by absorbing the vibration energy into an MMA element and/or by converting the vibration energy into electric power. The electric energy can be dissipated to heat or led out from the device. In the latter case, the device works as a power generator. The MMA material here is defined as a material whose dimensions change when a magnetic field or stress is applied to it, based on twin boundary or austenite-martensite phase boundary motion or magnetostriction.

The MMA element (active element) is a piece of an MMA material used as an active part(s) of the devices. The MMA element can be, e.g., a monolithic material of single crystalline or textured or randomly oriented polycrystalline structure, and appropriately shaped for the purpose, or it can be composed of two or more pieces of an MMA material. One example is a lamination. Two or more elements can be put together, e.g., using an elastic material. As an example, several Ni—Mn—Ga pieces were fixed together with an elastic resin. The elastic properties of the resin were so designed that the resin acts as a biasing spring.

Over 4% recovery was measured in the dimensions of the MMA element after elongating the element by a magnetic field. Lamination is also used to reduce eddy currents that arise due the alternating magnetic flux in an electrically conducting MMA element. Particularly, this is important at high frequency applications and when a small response time is necessary. Lamination can be made in different directions. For example, the MMA element a with large cross-section can be divided into many MMA elements with smaller cross-sections. The MMA element can also be a composite structure in which the MMA material is immersed in an elastic matrix, for instance (but not limiting to) an elastomer, as particles, fibers or plates. Those pieces of the MMA material can be oriented before solidification of the matrix, for instance (but not limiting to) an elastomer, as the pieces, e.g., fibers align along each other, or the orientation can be performed by applying a magnetic field on the pieces. Advantages of the lamination or composite structure of the MMA elements are a decrease of eddy current, and smoother motion of the laminated MMA element or the composite, by averaging the small steps of individual elements caused by the motion of individual twin or phase boundaries, and “built-in” bias spring of the MMA element.

An MMA device is composed of at least one active element and of at least one electromagnet. In addition, it can include a magnetic flux path, called a yoke, and/or at least one bias magnet, and/or at least one mechanical or electromagnetic device for returning the active element to its original size/position. For the proper operation of the device, the bias magnet(s) are located in the device is such position(s) that they produce magnetic field to the active element, and at the same time the alternating magnetic field produced by the electromagnet is minimal inside them, and demagnetization of them is minimized, i.e., the demagnetization field strength produced by the coils is lower than the coercitive force of the permanent magnets. The material of the active element can be (but not limited to) a Heusler alloy, e.g., Ni—Mn—Ga- based, or Ni—Co—Al. It can also be a Co-, Ni-, Mn-, or Fe-based alloy, e.g., Fe-Pd or Ni-Co. Also magnetostrictive materials, such as Fe-Dy-Tb or Fe-Ga alloys can be used. The yoke is made from a ferromagnetic material, often from a high permeability material. In some cases the yoke can be made from a high coercitive material. For instance, in actutors high coercitive yoke makes it possible to magnetize the yoke permanently in one direction with the magnetic field of the electromagnet (also by using a short pulse). When the current is removed from the electromagnet, the magnetization remains in the yoke (and in the active element). The magnetization of the yoke can be removed by the magnetic field in an opposite direction, generated by leading a current in opposite direction to the electromagnet. This type of actuator operation is useful, e.g, in certain bi-stable devices (for example valves, switches, fiber optic switches, electrical circuit breakers, relays or connectors). The yoke can also be composed of separate parts. The parts can exhibit diffent magnetic properties, e.g., the outermost part can be made from a high coercitve material to act as a bias magnet. In some applications the whole yoke or a part of it may work as a bias magnet, or there can be a separate part working as a bias magnet. It is also possible that different portions of the yoke have different magnetic properties, e.g., the carbon content of the yoke is varying along the yoke. The yoke may be composed of electrically insulated sheets of a ferromagnetic material, or the yoke can be made from a composite including ferromagnetic particles in an electrically insulating matrix, e.g., in a polymer, to reduce eddy current losses caused by alternating magnetic field. Bias magnets can also be made from Fe—Bo—Nd, Co—Sm, Al—Ni—Co, or Co-based alloys.

In the following text the actuator operation of the devices according to the invention is described first, and after that the damping and power generation operations of the device are described.

Actuator devices

Many MMA actuator devices have been built. Typical measured current vs. strain relationship of an actuator (type of Example 26) is shown in FIG. 41. The risetime of an actuator can be very short. As low risetimes as 0.2 ms have been measured. The risetime depends on the moving mass, generated force and the length of the motion. FIG. 42 shows an example of the measured strain and current in a fast motion application. The measurement wa done with an devise shown in Example 26. The measured acceleration is 5000 m/s² and the speed is 1.3 m/s. This kind of high acceleration makes it possible to use the actuators at very high frequency, up to several kHz. Actuators can be driven hundreds of millions of times with an alternating magnetic field without breaking the active element.

A unique property of MMA actuators is also a very high positioning accuracy. Positioning accuracy of 100 nm has been measured with rather robust actuators, and still higher accuracy is possible to reach.

The output stroke of the actuator depends on the length of the MMA element and the force on the cross-section area of the MMA element. These in turn affect the dimensions of the MMA actuators. Actuators with forces up to 1 kN and actuators with a stroke of 5 mm have been built, but even higher forces and strokes are possible to reach. The maximum strain of an actuator as a function of output load can be seen in FIG. 43. Measurement was done with an actuator type described in Example 36. It demonstrates that high forces are possible to reach with an MMA actuator.

MMA elements can also bend in the magnetic field. Such elements are shown in FIG. 53. Many of the devices shown in the examples below can also be used for bending elements. The element can be bent by applying to it a magnetic field of a certain direction. The element can be restored by the magnetic field of the other direction, or by a mechanical force caused, e.g., by a spring load or a force produced by permanent magnets. FIG. 53a shows a bending MMA element and FIG. 53b shows a bending element that is composed of two layers; an MMA layer and the base mterial. The MMA layer can be initially a monolithic MMA plate that is joined, e.g., by adhesion, gluing, soldering, brazing, welding, by a shock wave or the like methods, to the base material, called the substrate. The substrate may be metallic, ceramic, polymeric, silicon, Ga-As, composite or some other suitable material. The substrate can also act as the spring load that restores the initial shape of the MMA elemert. The substrate can also be an MMA material whose magnetic-field-induced shape change is different from that of the upper MMA layer. The bending element may be composed of three layers, the middle layer being passive and the upper and the bottom layers being made from the MMA materials that operate in opposite directions. One way of operation can be such that the upper layer expands and the bottom layer contracts in the magnetic field. The recovery can be performed by the magnetic field that is applied in the different direction, or mechanically. The MMA layers can be of single crystalline or textured or randomly oriented polycrystalline materials. Single crystalline and textured maerials can be made by cystral growth methods, rapid solidification methods or by deformation. Thin films can be made by sputtering, laser ablation or by other methods on a substrate. We have demonstrated that, e.g., a working Ni—Mn—Ga film is possible to grow by the laser ablation method. The suitable substrate can be deposited with interlayers. Micro MMA devices will be important in many applications in the future. Most of the example devices shown below are applicable also in the micro scale. Small MMA elements can also be made from thin MMA plates using lithographic methods.

Pulse controlled operation of the MMA actuator

The MMA actuator can also be used in Pulse Controlled Operation (PCO). In this type of motion the actuator shaft moves with current pulses and remains in specific position after the current pulse is over and the dynamic effects have been removed. There are two types of PCO motion: Current Irreversible PCO (CIPCO) and Current Reversible PCO (CRPCO) motion. When the actuator is used in a CIPCO motion, the MMA element cannot be operated in two directions with a current, e.g., to expand and contract. However, even in CIPCO motion it is possible to move the MMA element in an opposite direction with a mechanical load. In the CRPCO motion the element can be expanded and contracted with the current.

An example of the CIPCO motion of the MMA element is shown in FIG. 44, where the actuator does not have a biasing permanent magnet or a returning mechanical load such as a spring. FIG. 45 presents a schematic stress-strain curve of the MMA element under the PCO motion. In the example case of FIG. 44, the stress strain state of the MMA element in the beginning is at point A (see FIG. 44 and FIG. 45). When the current is led to the coils of the actuator, the MMA material generates stress and strain and the element starts increasing finally reaching the point B. When the current is reduced to zero, point C is reached. It is depending on the material parameters how large the strain difference between points B to C will be. In the case of example shown in FIG. 44, this difference is small, which is often the case.

A CRPCO actuator can be configured in several ways. For example, the actuator can be constructed in such a way that it can generate magnetic fields in two directions. Magnetic field in one direction can elongate the element and the field in the other direction (e.g., 90 different from the first direction) can shorten the MMA element. Similar result can be achieved with a mechanical load. Measurement results of an example of a reversible motion are shown in FIG. 46, where the actuator has permanent magnets and a mechanical spring. In this case the DC magnetic field is used to generate e CRPCO motion. The stress strain curve of this case is the same as shown in FIG. 45. The motion starts from point E (see FIG. 45 and FIG. 46). Point E is determined by the external spring load and the DC magnetic field that generated stress of the MMA material. When the current is led to the coils of the actuator, the MMA element generates more stress and it extends reaching point B. When the current is reduced to zero, the stress-strain state moves to point F. When we change the direction of the current the resulting DC field is reduced, and the stress strain state of the material moves to point D. Removing the current puts the operation point back to point E.

An example of an MMA actuator that can be actuated in a conventional way (not pulsed) or by magnetic pulses is given in FIGS. 47a and 47b. The difference between the cases shown in FIG. 47a and 47b is that in FIG. 47a the MMA element 1 has round cross-section and in FIG. 47b the cross-section of the MMA element 1 is rectangular. Coils 2a and 2b create the magnetic field in the vertical direction (H_{Y}) and coils 2c an 2d in the horizontal direction (H_{y}). Magnetic core 4 is used for the coil support and for the reduction of stray fluxes and necessary magnetomotive forces. In principle, the ferromagnetic core 4 can be omitted and then the device will be lighter. Unfortunately, this requires bigger magnetomotive force and pulse energizing is reasonable to reduce the heating of the coils and MMA element.

An MMA device works in the following way. When the coils 2a and 2b are energized, they create magnetic field H_{y} in the vertical direction. These fields penetrate inside of tube 4 and create deformation of the MMA element 1. When we have field H_{y} only, the MMA element expands in the horizontal direction and compresses at the same time in the vertical direction.

When we de-energize the coils 2a and 2b and energize the coils 2c and 2d, we have magnetic field Hₓ in the horizontal direction. Therefore, the MMA element expands in the vertical direction and compresses at the same time in the horizontal direction. The situation is opposite in comparison with the previous case. Similar effect arises by using two-phase current for the coil energizing.

Main disadvantage of this solution is that the maximum resulting field in the MMA element is determined alternatively by one pair of coils only. The second disadvantage is that two power sources are necessary for coil supplies. Because the MSM element has magnetic anisotropy, the rotating torque can arise when coils are energized simultaneously. This torque can produce in some cases damage of the MSM element. Therefore, the best results are obtained, when magnetic field is produced either by coils 1 or by coils 2.

In FIGS. 48a and 48b, the solutions are presented in which both core pairs create the magnetic field into the MMA element at the same time. Therefore, the magnetomotive forces and losses can be reduced. In these figures, coils 2a and 2b are supplied by an alternating current (AC) and coils 2c an 2d by direct or rectified current without changing of polarity. For this purpose, for example, the same current that flows through coils 2a and 2b can be rectified for coils 2d and 2c. As shown in FIGS. 48a and 48b, the resulting magnetic field changes its position in the MMA element approximately onto 90 degrees (between H₁and H₂) and we have the same effect as in FIGS. 47a and 47b. In addition, only one power source is sufficient to supply the device.

To simplify the construction and to reduce the power consumption in FIGS. 49a and 49b there are presented solutions, in which coils with the rectified current are replaced by permanent magnets 3a and 3b that create field Hₓ in the horizontal direction. This also simplifies the power electronics that is necessary for the coil supply.

As an example of the MMA device, one is built and tested according to the principle given in FIG. 49. Each of the coils has 980 turns of copper wire with a diameter of 0.71 mm. The resistance of the coils is 2 −3.4Ohm. In FIG. 50a,the magnetic field distribution is given at the coil current +2 A and in FIG. 50b the field is given at the coil current −2 A. It is clearly seen that the magnetic field changes its orientation inside the MSM element by 90 degrees and produces the shape change of the MMA element

Electric power generators

The change in the shape of the MMA element also alters the permeability of the element. If an MMA actuator has a magnetic field (e.g., generated with permanent magnets) in its magnetic circuit, the change of permeability changes the flux Φ_{c} in the circuit and generates voltage uₑ to the coils of the actuator. If the actuator's coils are connected to closed circuit, the instant value of the generated voltage uₑ is defined by the differential equation:

$${u}_{e} = Ri + N \frac{ⅆ {Φ}_{c}}{ⅆ t} = Ri + \frac{N}{{l}_{MSM}} \frac{ⅆ {Φ}_{c}}{ⅆ ɛ} v , \qquad ( 1 )$$

where N is the number of the coil turns, /_{MSM} is the length of the MMA element, t is the time, v is the speed by which the MMA matrial changes its shape, R is the resistance of the coils and the i is the current of the coils. Therefore, the induced voltage depends on the geometrical and material parameters of the MMA actuator, the induced curent, as well as on the speed of the MMA material.

By changing the shape of the material mechanically we can, therefore, generate voltage pulses which in closed circuit can generate current i. An example of a measured current pulse generated with the described method can be seen in FIG. 1c. The instant value of generated power pₑ i
pₑ=uₑi. (2)

In the case of FIG. 1c, the measured specific generated electrical energy is Wₑ= 3.6 kJ/m³ per cycle.

Vibration damping devices

Most MMA materials exhibit high vibration damping capacity. This is based on a hysteretic motion of twin boundaries or interfaces between austenite and martensite. The mechanical energy consumed per volume W_{mech}/V in one cycle can be calculated by integrating the hysteresis loop area

$$\frac{{W}_{mech}}{V} = ∮ σ d ɛ \approx 2 {σ}_{TW} {ɛ}_{max} , \qquad ( 3 )$$

where σ is stress, ε is strain, σ_{TW} is the stress in the middle of the hysteresis loop (see FIG. 47) and εₘₐₓ is the maximum strain. An example of a measured mechanical hysteresis loop can be seen in FIG. 47. With approximate formula, Eq. 3, the damped mechanical energy per volume W_{mech}/V in one cycle is 170 kJ/m^{3.}

High damping capacity is an advantage also in actuator use of the MMA devices, because fast magnetic-field-induced motion of the MMA element can be abruptly stopped without structural vibrations or overshooting of the element. This is of special importance in fast proportional positioning devices.

Another source of vibration damping capacity of the MMA devices according to the invention is dissipation of the electric power generated by the device. This kind of damping is tunable. The dampened mechanical energy W_{damp} transforms into the magnetic energy W_{mag}, electrical energy Wₑ and to the internal mechanical losses W_{mech} of the MMA element
W_{damp}=W_{mag}+Wₑ+W_{mech}

Therefore, the damping capacity depends on how high is the output electric power of the actuator. The alteration to this power can be done, for example, by changing the load resistance connected to the coils of the MMA device.

In many vibration damping applications it is important to shift the resonance frequency of a vibrating machine. Such examples are motors, engines or paper machines. MMA devices makes it possible to change the stiffness of the structure and thereby shift the resonance frequency even for a very short time when necessary. This is based on a special feature of the MMA materials that their elastic modulus can be changed by a magnetic field. The modulus can be changed even by a factor of 10. This is due to the hysteresis bahaviour of the twinning stress. When the operation occurs in the center of the main hysteresis loop the elastic modulus is small. When the material is operated in the saturation region of the main hysteresis loop, the elastic modulus is high. If the MMA material is placed in a magnetic field, it will generate stress, and the operation region will be in saturation. On the other hand, without the field the operation region of the MMA material is in the center part of the mechanical hysteresis loop. Therefore, the introduction of the magnetic field changes the elastic modulus of the material.

Especially suitable MMA devices for this purpose are such devices in which two or more MMA devices work against each other. Such examples are Example 3, 4, 5, 6, 15, 16, 22, 23, 24, 25 and 26. Applying the magnetic field does not produce motion, because the forces generated by the opposing devices compensate each other. The net effect is stiffening of the MMA elements.

The simplest damping device is composed of one MMA element and one bias magnet that produces magnetic field perpendicular to the loading direction of the element. This is shown in FIG. 52.

High vibration damping capacity of the devices according to the invention was demonstrated using a device shown in Example 36. The device was dynamically loaded with a sinusoidal strain amplitude of 0.25 mm and at different frequencies ranging between 1 and 10 Hz. The constant magnetic field (flux density 0.59 T) was generated by the electromagnet of the actuator. The vibration damping capacity was very high; loss coefficient was measured to be as high as 0.7.

This invention exhibits a large industrial potential in a variety of fields of use. The devices can be used, e.g., in valves, pumps, injectors, biomedical devices, positioning devices, robots, manipulators, shakers, vibrating devices, vibration dampers, electric generators, microsystems, fiber optic switches, electrical connectors and circuit breakers.

### EXAMPLES

The following examples are embodiments of the principles described above Devices shown in the following examples can be actuators, electric power generators or mechanical vibration damping devices. It is emphasized that the examples are not limiting the invention, but just to demonstrate the operation principle of the device. The devices are according to the invention even if dimensions, shapes and/or number of different components of the devices are different than shown in the figures of the following examples. It is also emphasized that the MMA element can be made from dfferent kinds of MMA materials. For instance, if the element is made from such an MMA material whose easy direction of magnetization is the short as of the lattice, e.g., Ni—Mn—Ga, the element contracts in the field direction and elongates in the direction of the long dimension of the element, when the devices shown in the following examples are used as actuators. If the easy direction of magnetization is a long lattice axis, the MMA element elongates in the field direction and contracts in the direction perpendicular to it. In some MMA materials, there is an easy plane. Such material is, for instance, Fe—Pd. In the following text numbering of Examples and Figures correspond to each other.

### Example 1

Device with a symmetrical structure has been presented in Fig. 1a. The device contains MMA element 1, coils 2a and b 2b, permanent magnets (PM) 3a and 3b and magnetic-circuit 4a, 4b and 4c. Outer boundary surface, piece 6, supports the MMA element and fixes its one end and other free end moves in the direction of the arrow. The support piece 6 can be removed and then the both ends of the MMA element may move in the opposite directions. Spring 5 is necessary as a source of the pre-stress force to restore initial shape of the MMA element when magnetic field decreases to zero. Instead of the spring, gravity or another force sources can also be used, for instance forces generated by external moving body or organ. Proper choice of cross-section areas and lengths of the permanent magnets allows avoiding the demagnetization, and it reduces losses.

Device operates according to the follwing principle. When the coil currents are missing, permanent magnets 3a and 3b the bias field in the magnetic circuit 4. The lines in FIG. 1a present the paths of this field and arrows show the directions of the field. As seen in Fig. 1a, a part of the field passes through the MMA element and creates the bias field of the MMA material. Depending on the application of the device, the value of the bias field can be chosen so that the MMA element does not extend, or it extends partially or totally.

Coils 2a and 2b are connected electrically in such a way that their magnetomotive forces are in the same direction. When extension of MMA earnt is required, currents are applied in coils 2a and 2b in such a direction that it increases the resulting field in MMA material. When contraction of MMA element is required, the direction of the currents is opposite and resulting field decreases. Therefore, the length of the MMA element remains the same or decreases due the outer force. The shortest value of the length is obtained at the zero result field inside the MMA material.

One measurement result is presented in FIG. 1b to demonstrate the operation of this device. In FIG. 1b, the displaceent is presented at different values of the coil currents for the free end of the MMA element 1. This characteristic shows a hysteresis because of a twinning stress of the MMA material. The lower is the twinning stress the narrower is the hysteresis loop width.

This device can also be used for generation of an electric power or for mechanical vibration damping applications. When an exteral force changes the shape of the MMA element, the permeability of the MMA material changes, which produces change of the flux linkage of the coils 2a and 2b. Time-changing flux linkage induces an electromotive force in the coils and thus the electrical power is generated, if the electric circuit is closed. In addition, a part of the mechanical energy associated with the external force dissipates inside of the MMA material due to the twinning stress. One measurement result of the power generation is presented in Fig. 1c. Here, the external force compresses the MMA element rapidly and then the external force is removed. It is seen that the current arises in the closed circuit when the applied force changes.

The vibration damping capacity of the device can be adjusted by the currents in coils 2a and 2b.

The device also operates if the permanent magnets are missing or, if instead of them we use ferromagnetic bodies. In addition, magnetic circuit parts 4a, 4b and 4c can be joined in one body, which simplifies the construction. As a drawback of this, we need bigger coils with higher magnetomotive forces. Therefore, loss power and response time are higher.

### Example 2

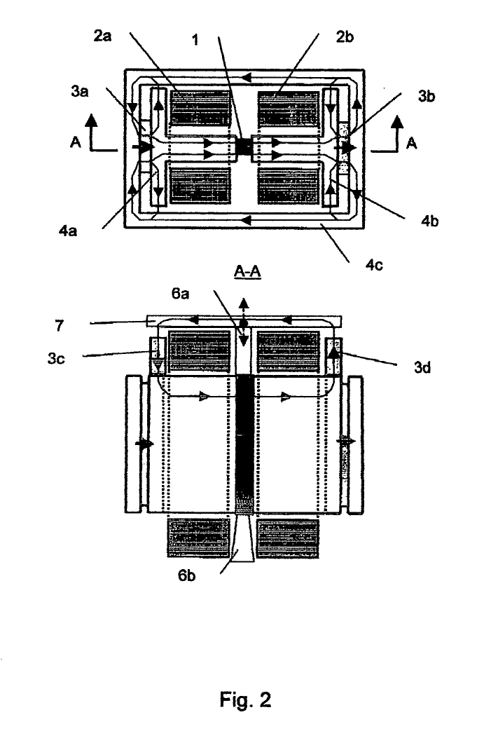

The structure of this device is presented in FIG. 2. The device differs from the device presented in Example 1 in the way that pressing spring is removed and compressive recovery force is generated by additional bias magnets 3c and 3d, because the magnetic flux is conducted through an auxiliary ferromagnetic part (piece) 7. Thus compressive recover force is generated as the magnetic trust force between part 7 and auxiliary magnets 3c and 3d. This force is applied to the MMA element by body 6a.

These permanent magnets can also be replaced by ferromagnetic pieces. Then part of the bias field generated by permanent magnets 3a and 3b goes in auxiliary part (piece) 7 as the leakage field controlled by currents in the coils 2a and 2b.

### Example 3

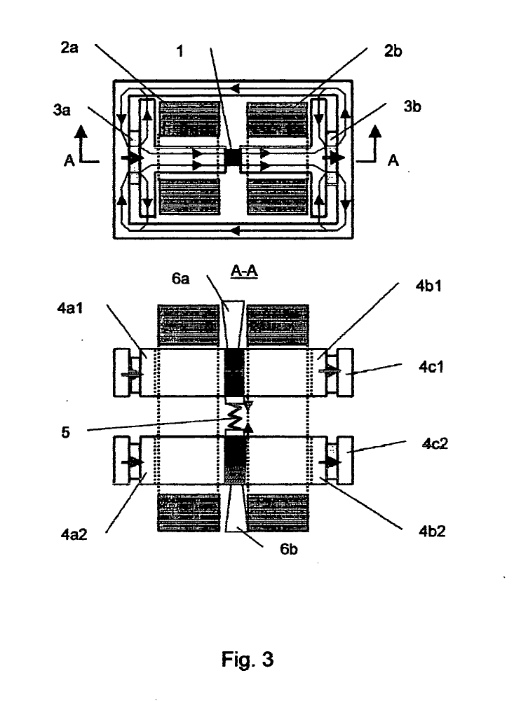

The structure of this device is presented in FIG. 3. Here we use two devices presented in FIG. 1a and they work against each other in opposite directions and apply forces to common body (organ) or spring 5 in FIG. 3. The MMA elements expands and contracts at the same time. Coils 2a and 2b are common for both devices but separate coils can be used as well.

### Example 4

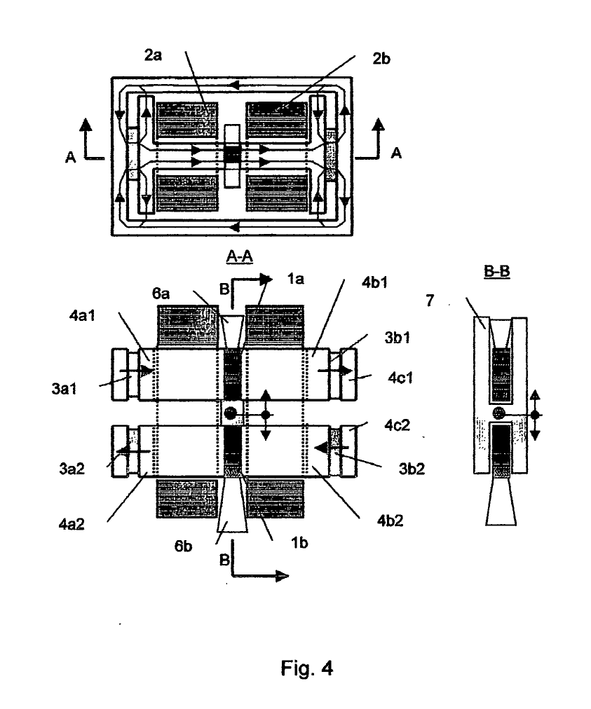

The structure of this device is presented in FIG. 4 and it resembles the previous case presented in FIG. 3. This solution allows producing reversible output motion (force) by body 7 without of the spring, because at the same time when one MMA element extends it compresses the MMA element in the other device. Thus MMA elements expand and contract by turns. Coils 2a and 2b are common for both devices but separate coils can be used as well.

### Example 5

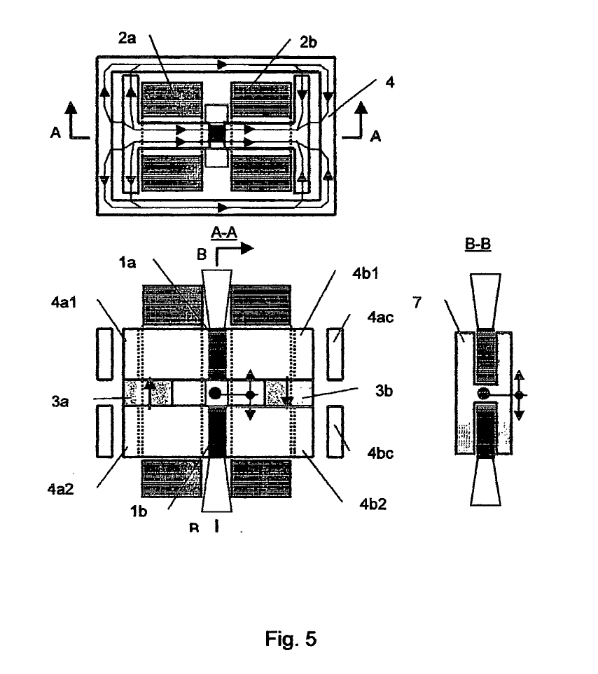

The structure of this device is presented in FIG. 5. This solution differs from the previous solution shown in FIG. 4 by location of the permanent magnets and by the method to generate bias field. Here the permanent magnets are common for both devices. Permanent magnet 3a is placed between parts of magnetic circuits 4a1 and 4a2, and permanent magnets 3b is placed between parts 4b1 and 4b2. The distribution of the bias field is shown in the upper picture of FIG. 5. Operation principle is the same as in Example 4.

### Example 6

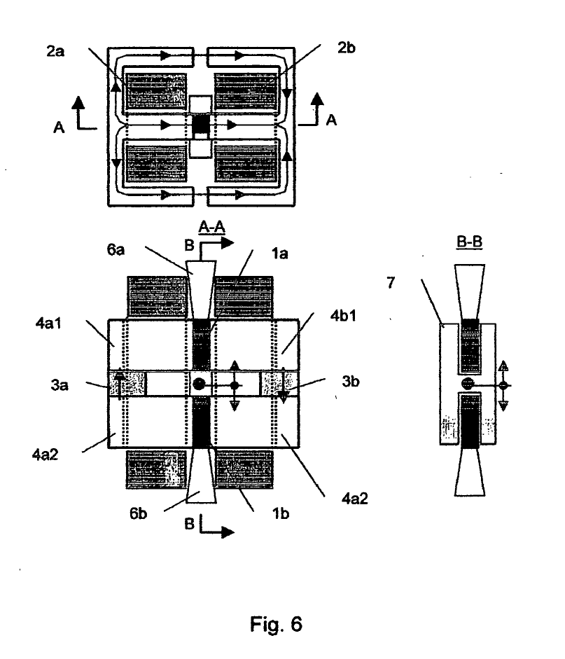

The device is presented in FIG. 6. In comparison with Example 5, here we have simpler magnetic circuit.

### Example 7

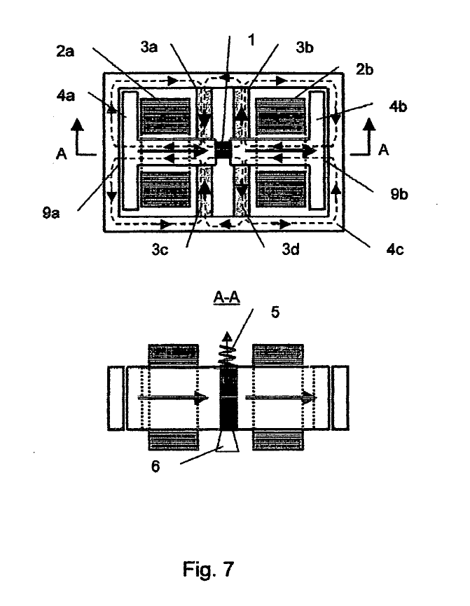

The device is presented in FIG. 7 and it contains MMA element 1, coils 2a and 2b, permanent magnets 3a, 3b, 3c and 3d, magnetic cores 4a and 4b and yoke 4c, pre-stress spring 5 and support end body 6. Permanent magnets 3a, 3b, 3c and 3d are located close to MMA element 1. Magnetomotive forces of the coils 2a and 2b are in the same direction. Depending on the requirements, the coils can be connected in series or parallel.

Permanent magnets 3a, 3b, 3c and 3d generate the bias field, the paths of which are shown by dashed lines. Because part of the bias field flow through the air gaps 9a and 9b, by proper design of them we adjust the value of bias field inside of MMA element 1. As a boundary case, these air-gaps can be zero.

The device operates according to the following principle. If we supply coils by the currents that magnetomotive forces in the directions presented in FIG. 7 then resulting field inside the MMA element increases. If we change the direction of the current, the resulting field decreases. In such a way we change the force generated by the MMA element and motion of its free end.

### Example 8

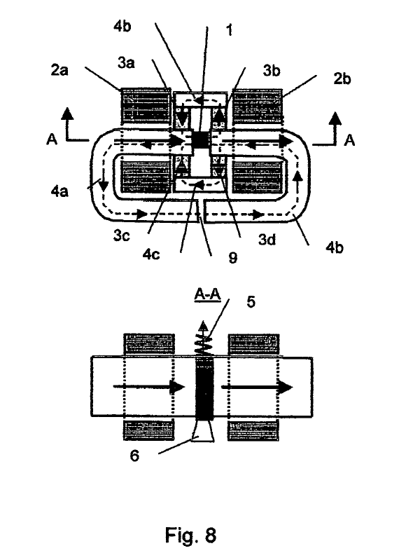

The device is presented in FIG. 8 and it differs from Example 7 by topology of the magnetic circuit that is assembled from two C-cores. The advantage of this topology is easy usability of grain-oriented steel, because changing-flux path has the same orientation as the grain orientation. Permanent magnets can be omitted if simplifiation is necessary but then bigger coils are needed.

### Example 9

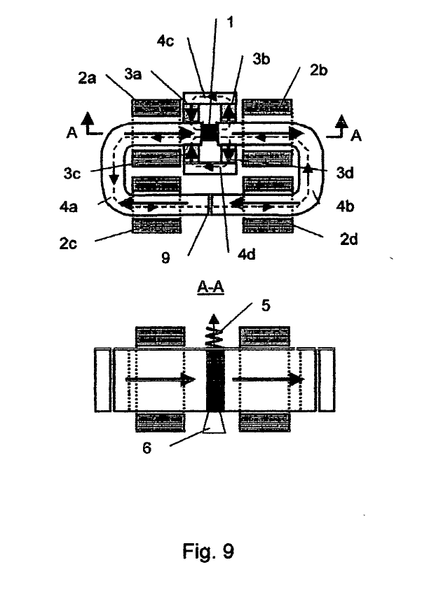

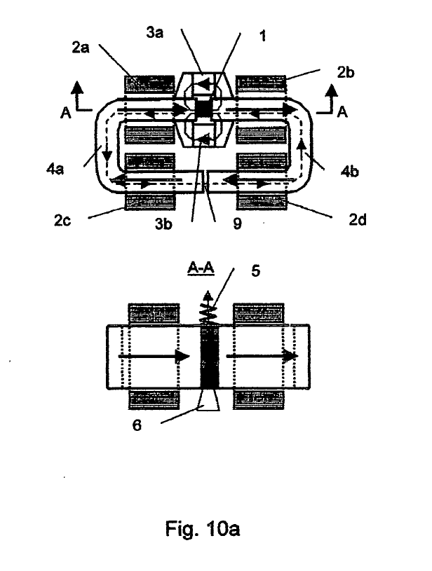

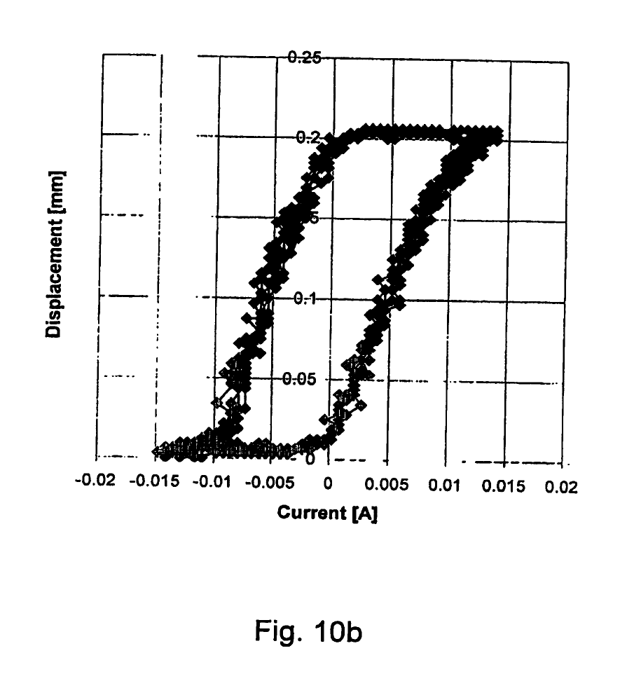

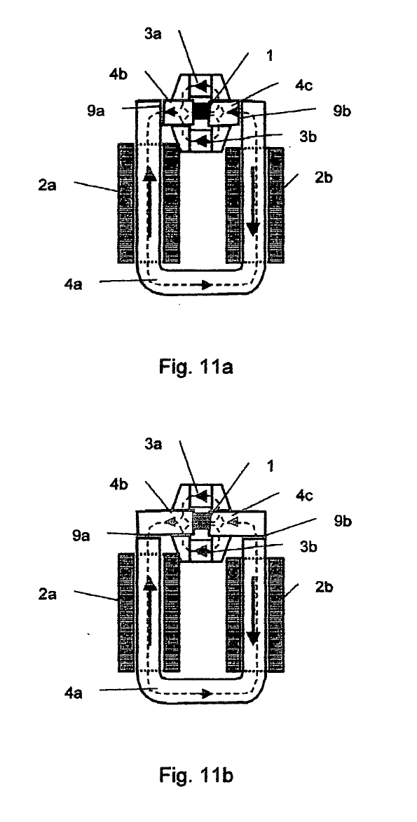

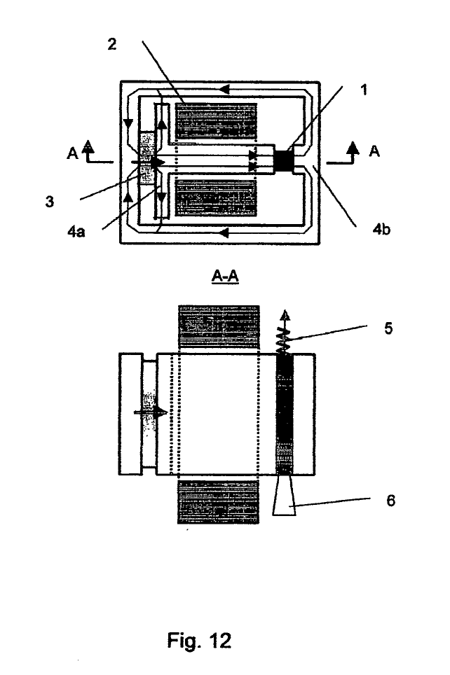

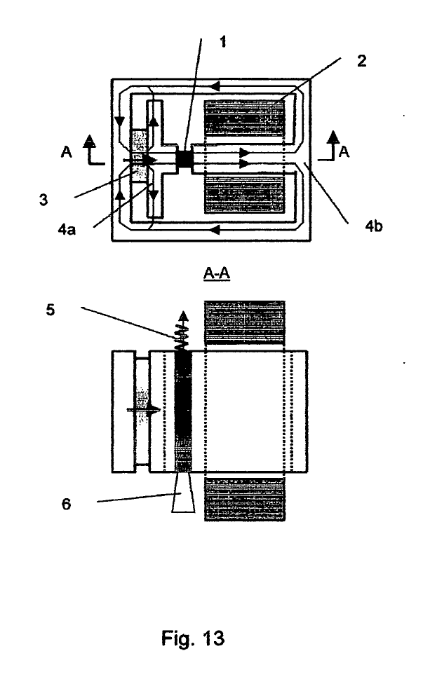

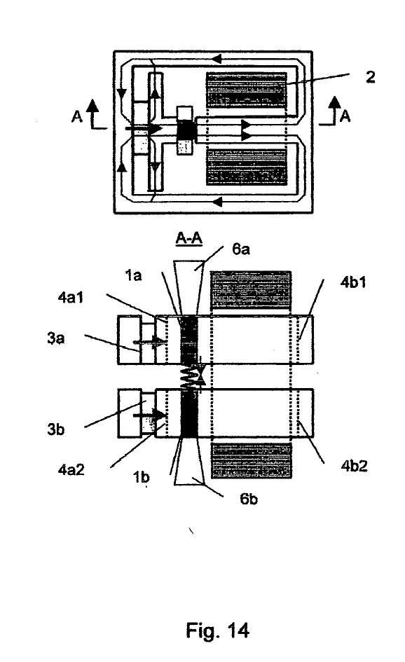

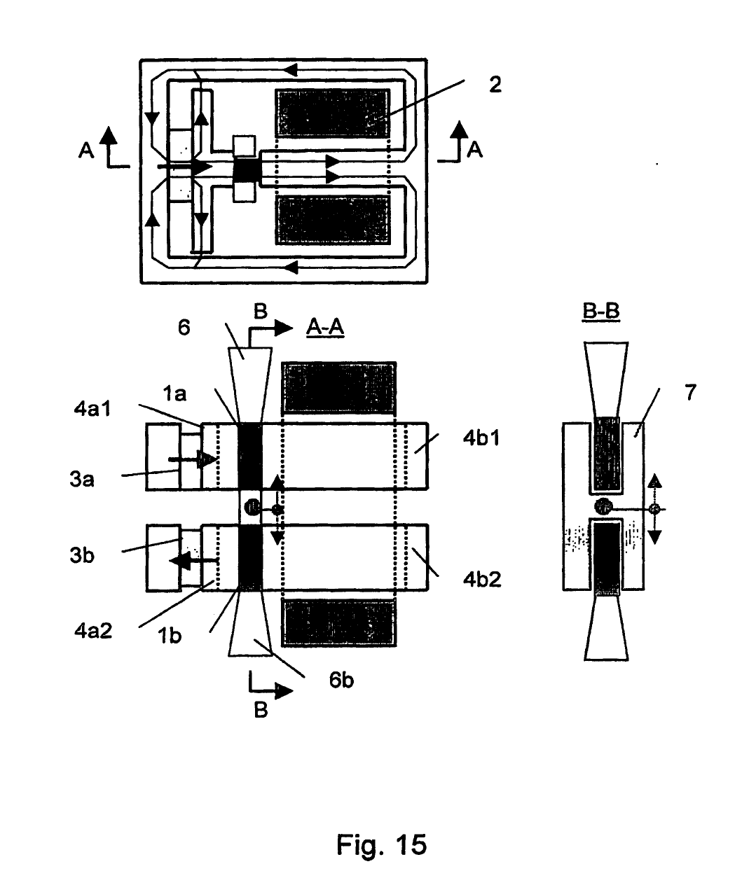

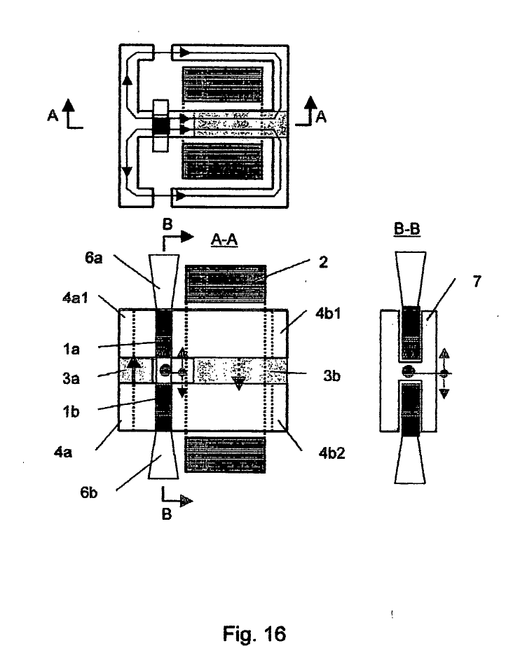

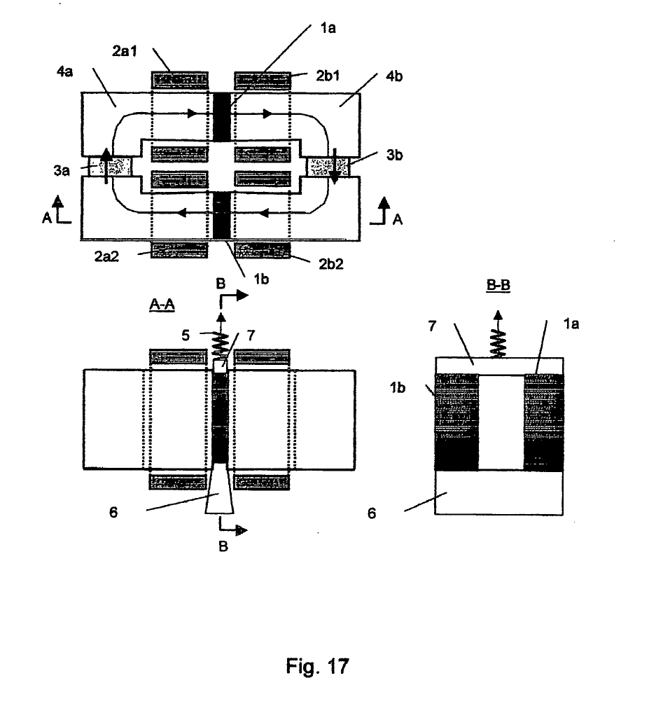

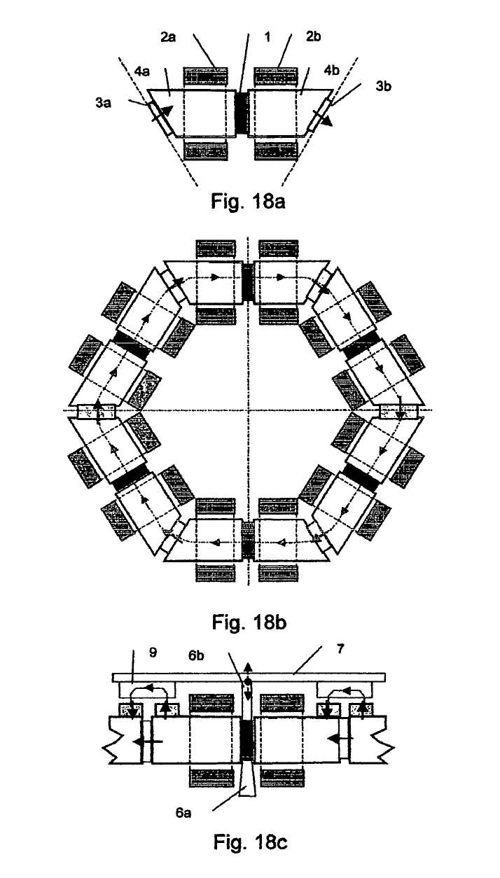

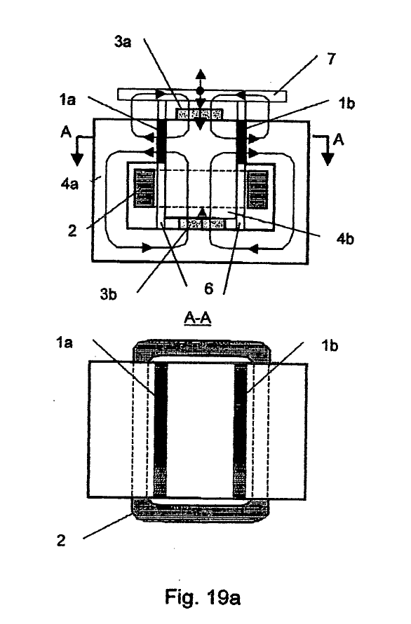

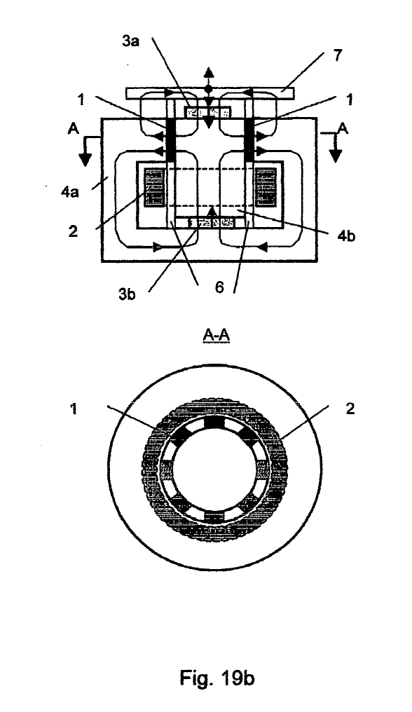

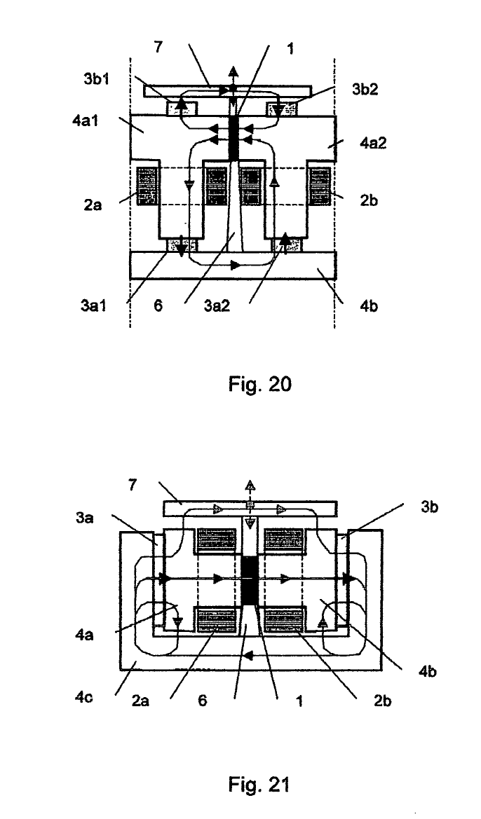

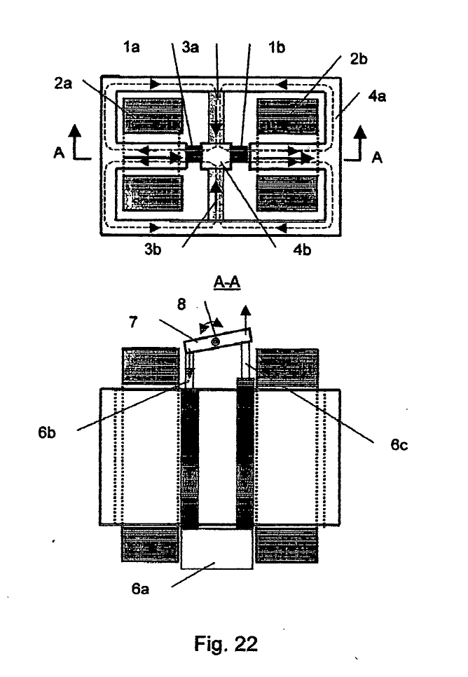

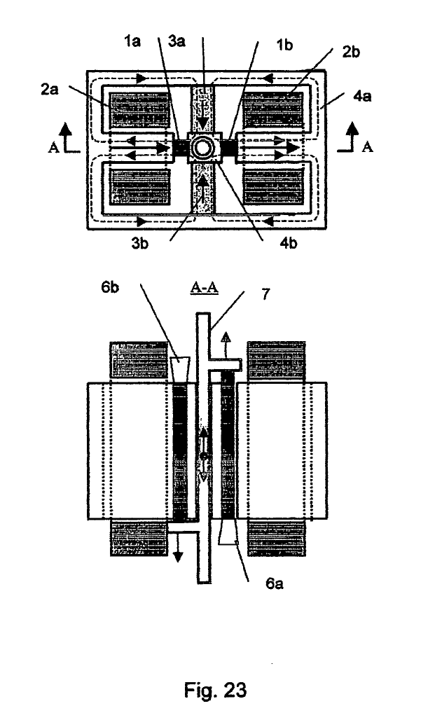

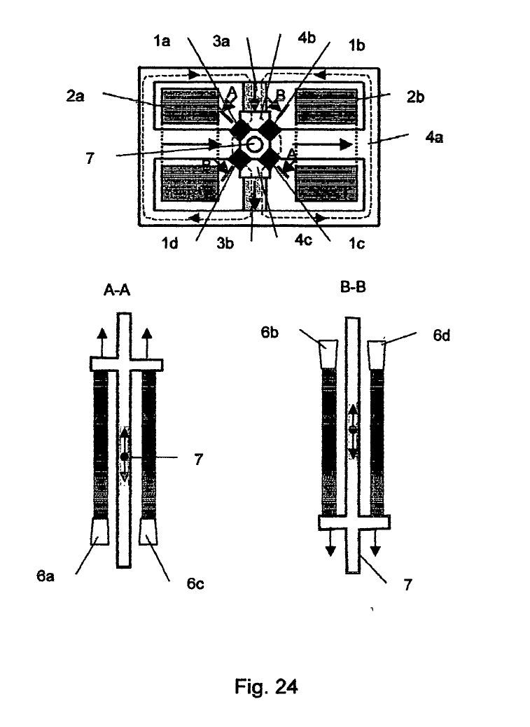

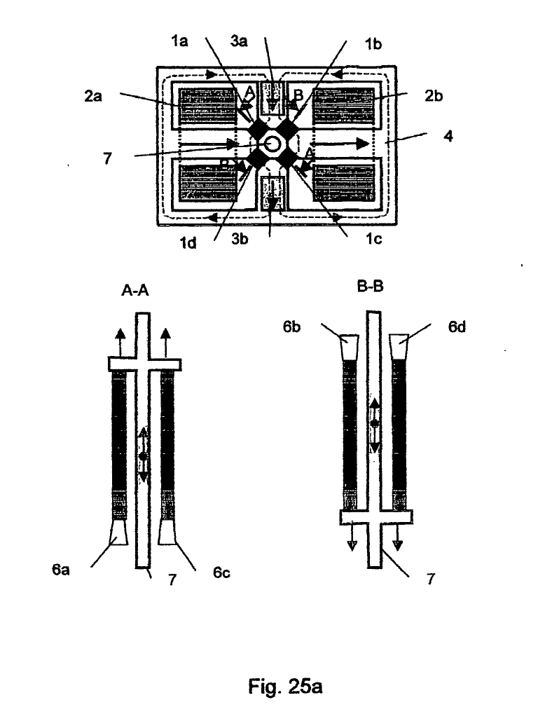

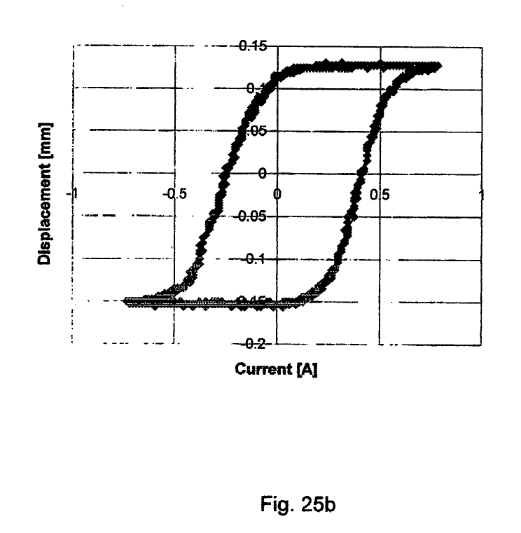

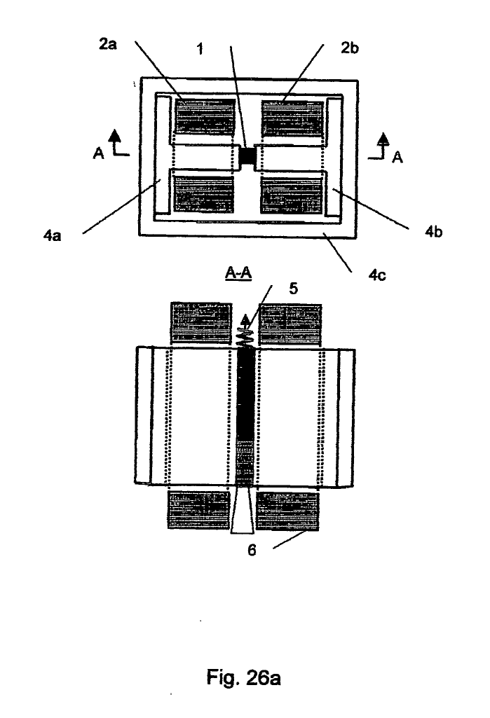

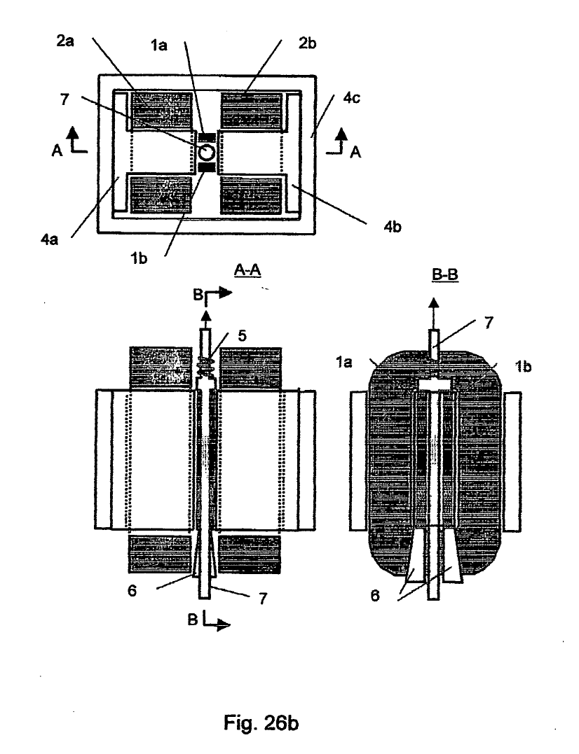

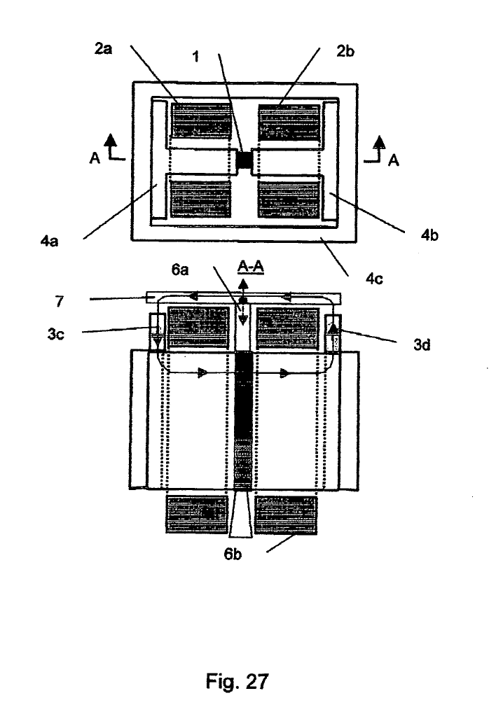

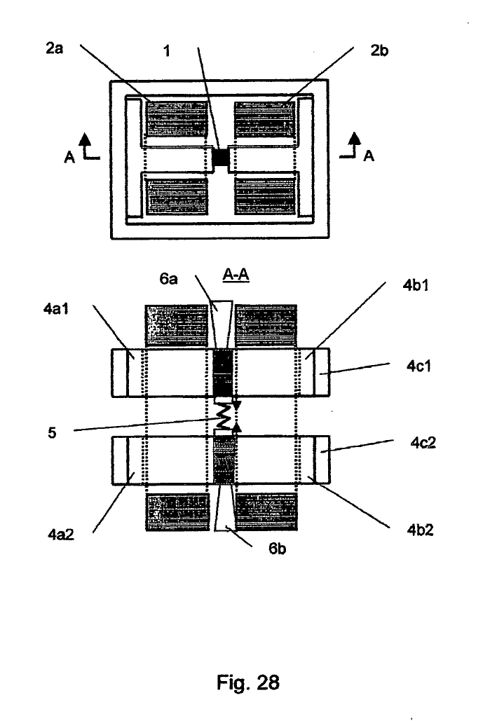

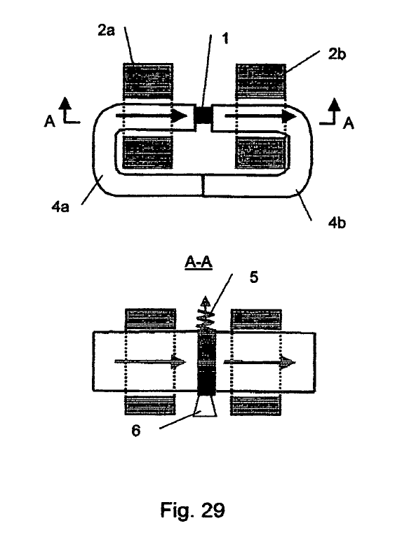

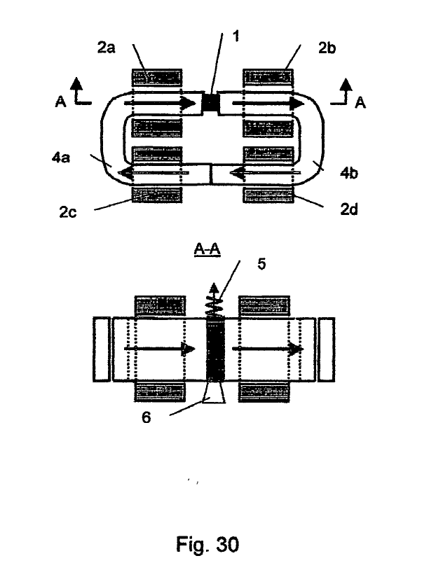

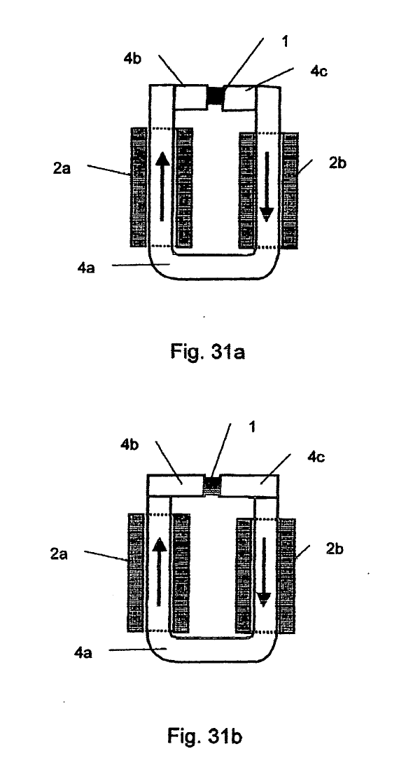

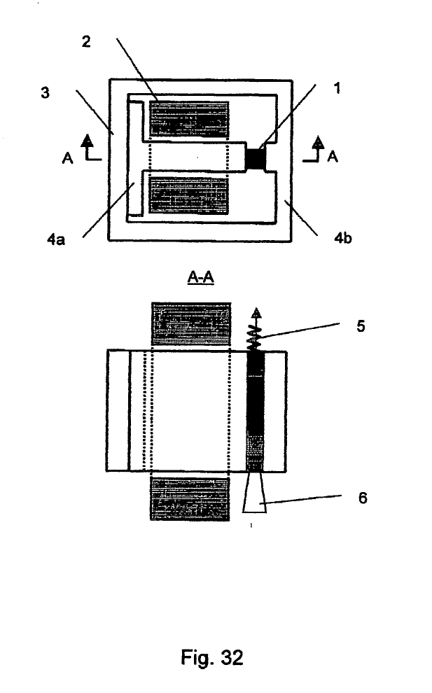

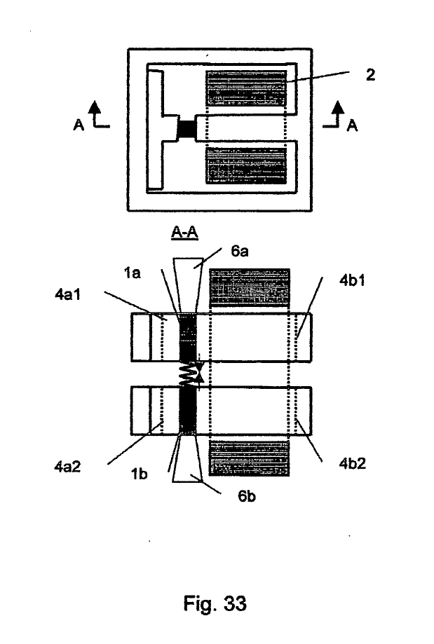

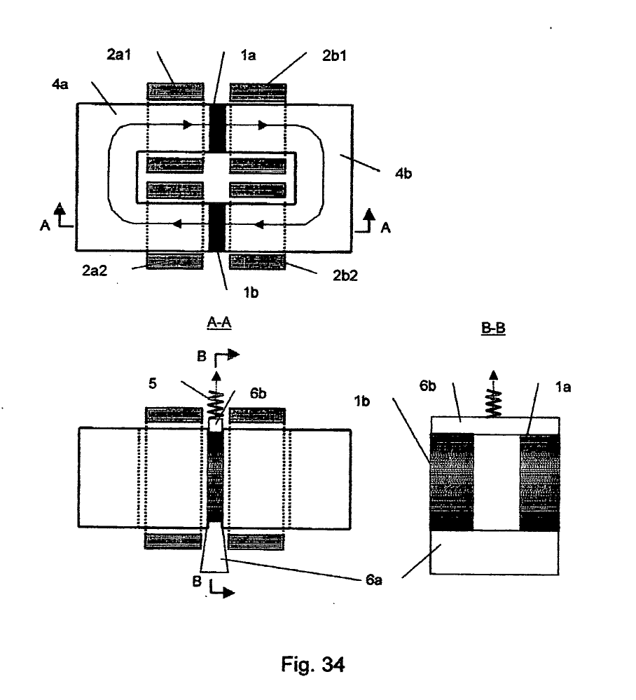

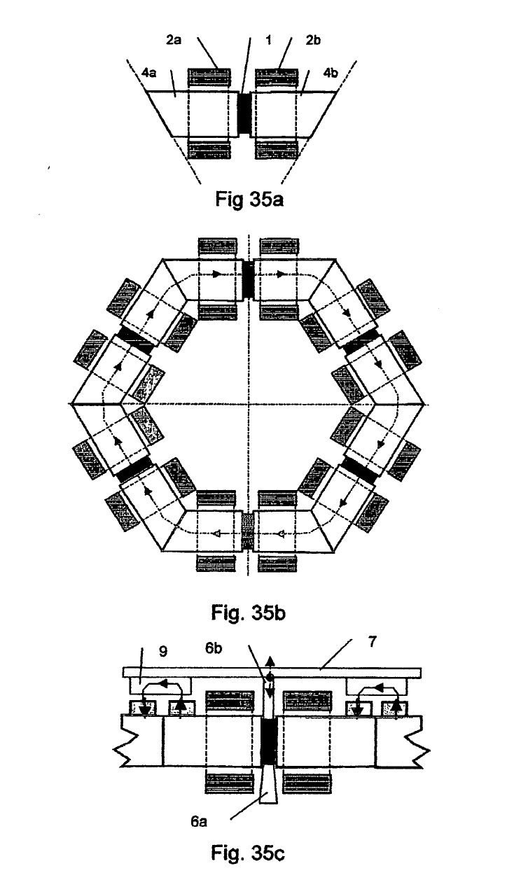

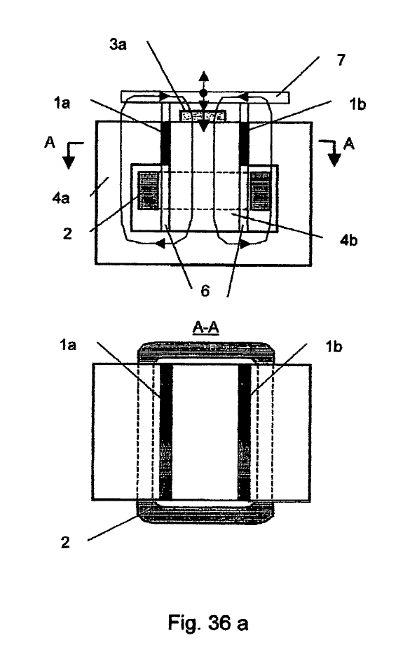

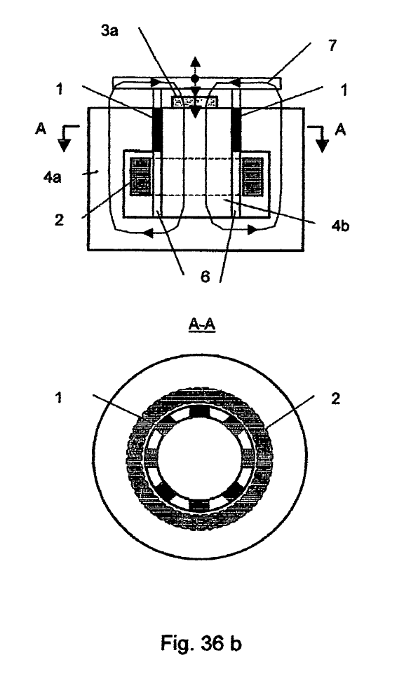

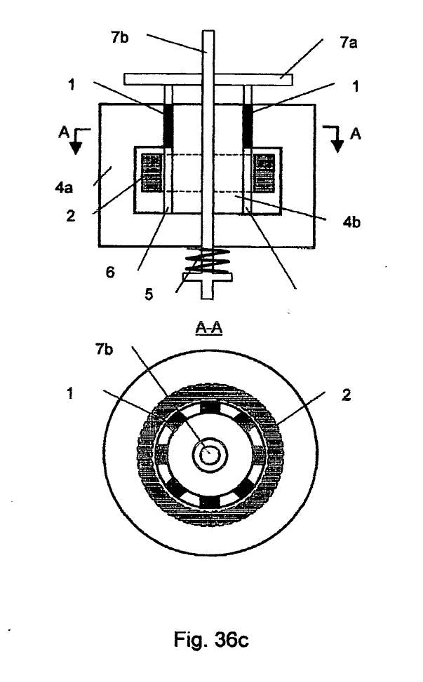

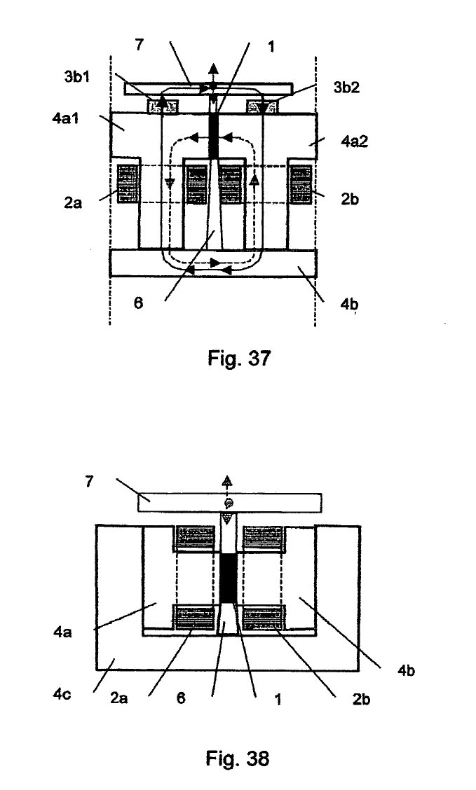

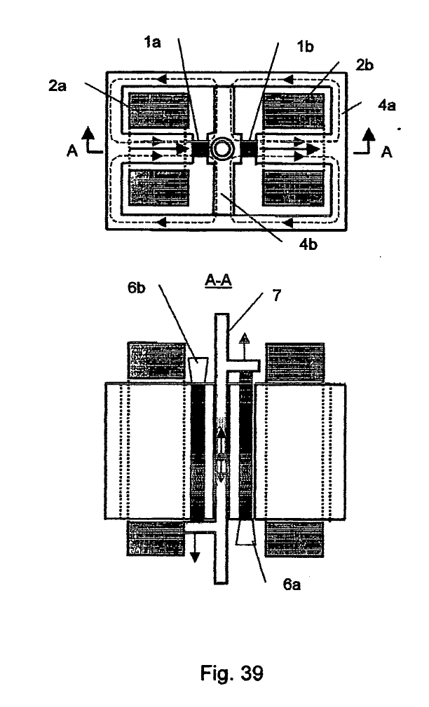

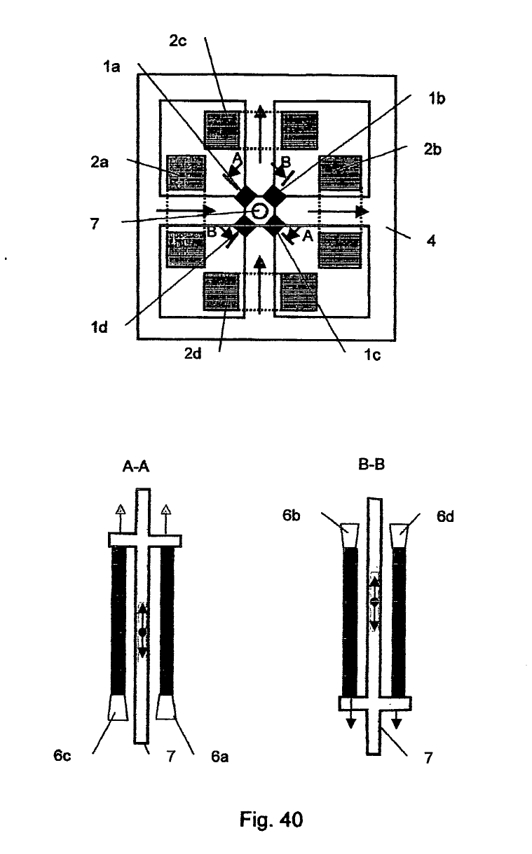

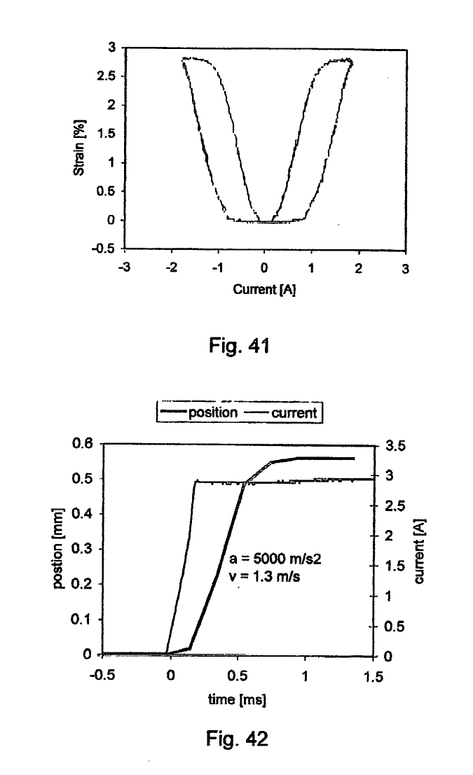

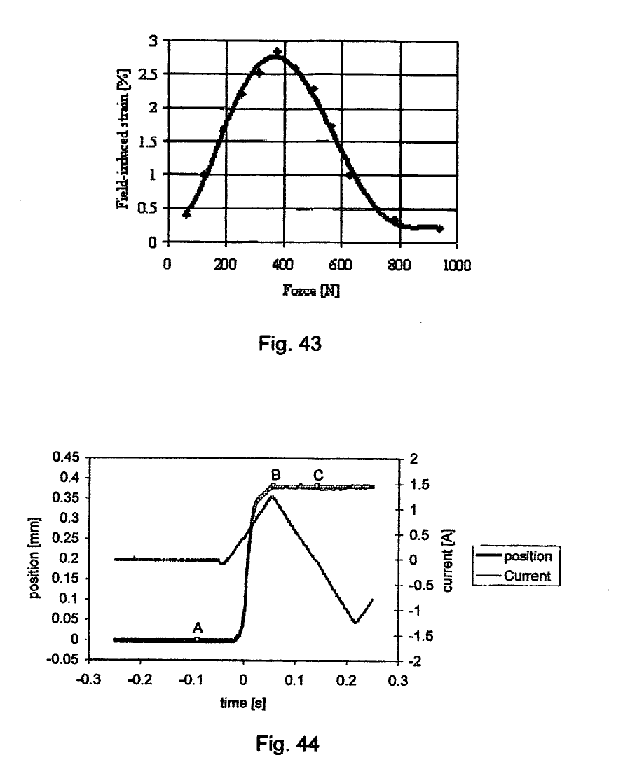

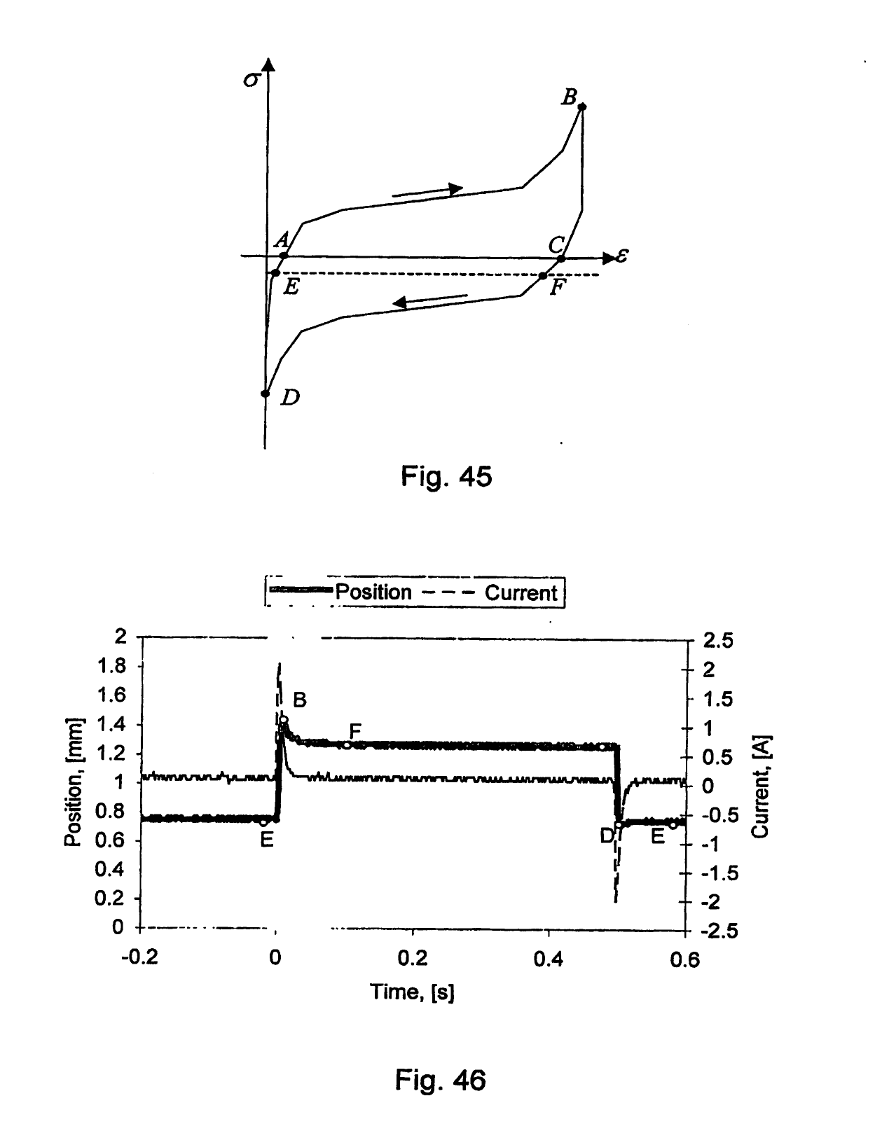

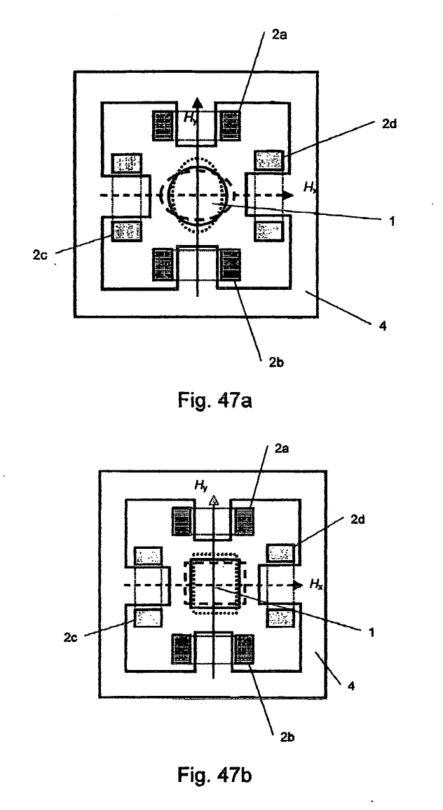

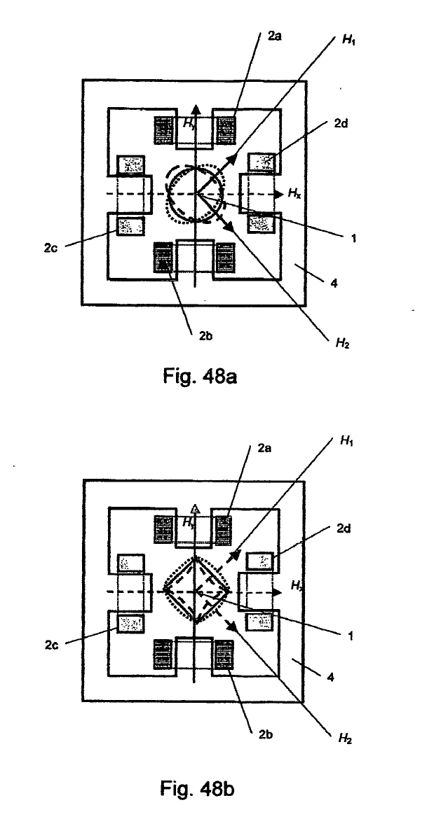

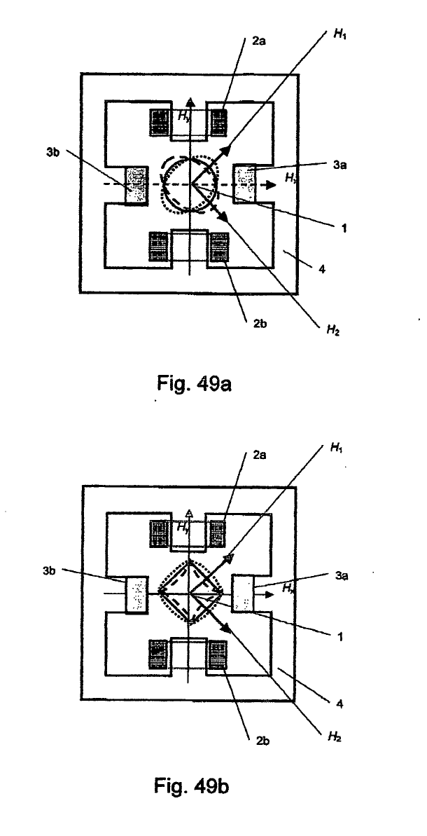

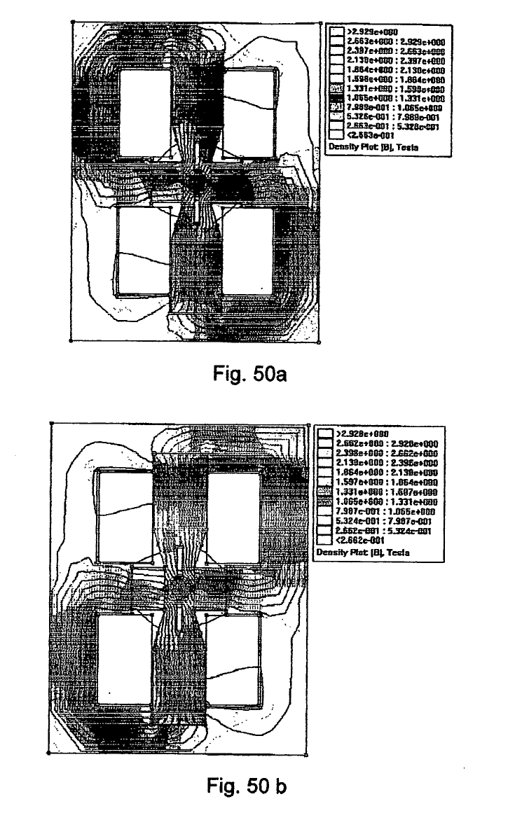

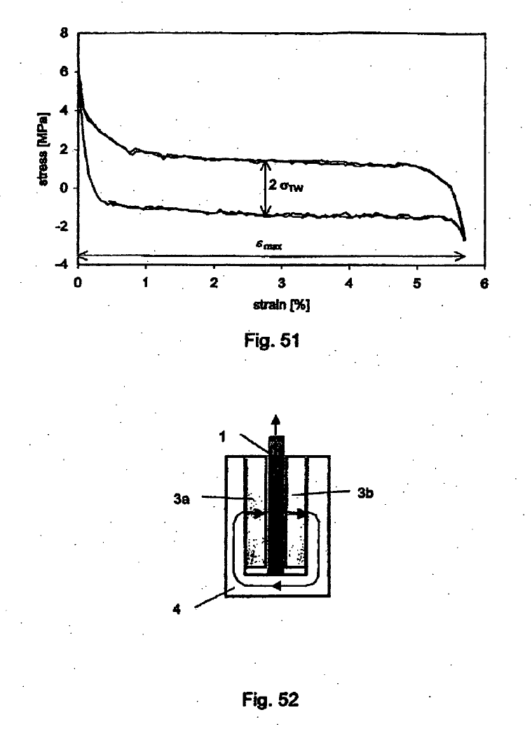

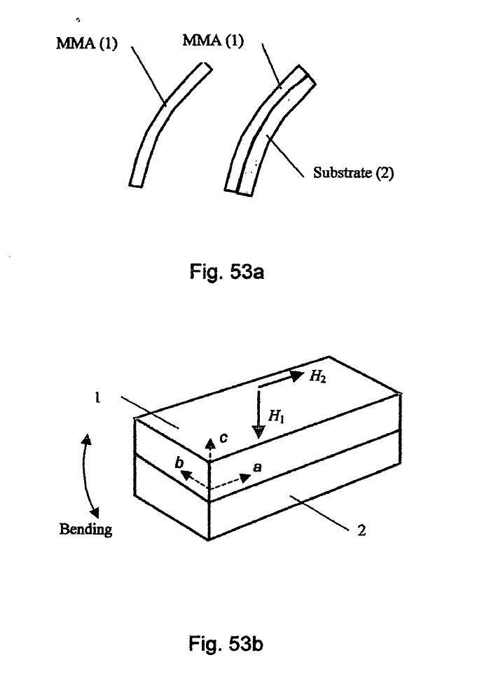

The device is presented in FIG. 9 and it differs from Example 8 only by the number of coils (four) and their location. Because coils are distributed on the magnetic circuit, the average length of the turns decreases and power losses are smaller. Furthermore, coils 2c and 2d can be united, which reduces average turn length.

### Example 10

The device is presented in FIG. 10a and it differs from Example 9 only by the number of permanent magnets (only 2 are necessary), and their location is a little different. The operation of this type of device is presented in FIG. 10b by experimental measurements of the displacement versus coil current.

### Example 11

The device is presented in FIG. 11a and Fig. 11b. It differs from Example 10 by the number of the coils that are reduced to two, and the magnetic circuit contains one U-core. This allows reducing the average turn length additionally. Best result will be achieved when the winding is manufactured from one coil that is homogeneously distributed along the magnetic circuit. Difference between devices in FIG. 11a and FIG. 11b is in the location of the air gaps 9a and 9b by which we adjust the bias field inside the MMA element 1.

All these solutions can be realized without permanent magnets but then size of the device and the loss will be higher.

### Example 12

This example is presented in FIG. 12 and the device operates in the same way as in Example 1. Here, we have unsymemetrical construction, and one coil 2 and one permanent magnet 3 are located in the same side of the MMA element 1, which simplify the construction of the device.

### Example 13

This example is presented in FIG. 13 and it resembles Example 12, but MMA element 1 is located between coil 2 and permanent magnet 3 and, therefore, the leakage magnetic field is lower.

### Example 14

This example is presented in FIG. 14 and it is like Example 3 but the magnetic circuit is simpler and its construction is unsymmetrical.

### Example 15

This example is presented in FIG. 15 and it is like Example 4 but the magnetic circuit is simpler and its construction is unsymmetrical.

### Example 16

This example is presented in FIG. 16 and it is like Example 6 but the magnetic circuit is simpler and its construction is unsymmetrical. Ferromagnetic body can replace one of the permanent magnets 3a or 3b.

### Example 17

This example is presented in FIG. 17. This structure can be used when high forces are required for the device. In this structure forces generated by MMA elements 1a and 1b are superimposed to each other, because mechanically they work in parallel. Magnetically MMA elements are connected in series. Such a structure improves the performance of the device, because MMA elements 1a and 1b extend and contract more simultaneously.

### Example 18

This example is presented in FIG. 18. In previous Example 17, two MMA elements worked mechanically in parallel and magnetically in parallel and magnetically in series. If high force output of the device is required and if the number of MMA elements is increased, then the device is reasonable to build with a modular structure as shown in FIG. 18a. Here MMA element 1 is located in the air gap between magnetic-circuit parts 4a and coils 2a and 2b generates field that varies according to the coil currents. In addition, at the ends of the magnetic circuits 4a and 4b permanent magnets 3a and 3b, that create the bias magnetic field, are placed. In FIG. 18b, we see the device structure that contains six modules, but the number of modules can vary starting from 3.

The design calculations show, for example, that such a type of the device for the fore of 20 kN and stroke of 3 mm has outer diameter 0.65 m and the weight about 90 kg.

In FIG. 18c we see one possible solution to create the pre-stress load for MMA elements without a spring. This principle is the same as described in Example 2, but ferromagnetic bodies 9 are added to create the magnetic force. Auxiliary bias permanent magnets can be omitted and then the leakage fields of the base bias magnets generate the magnetic forces.

### Example 19

This example is presented in FIG. 19a. This solution can be used when MMA elements 1a and 1b are placed in two separate rows. Use of the spring is not necessary, because pre-stress can be generated by bias magnets 3a that concentrates draft force to the ferromagnetic body 7. This solution can be easily realized with axial-symmetrical construction (FIG. 19b). In FIG. 19b, the magnetic circuit 4a and 4b, coil 2, permanent magnet 3a and 3b can have cylindrical construction. The MMA elements 1 are located inside of the cylindrical air gap. The bias field created by permanent magnets is presented by the lines and arrows. When we apply the coil current in the positive direction, the resulting field In the MMA element increases and it expands. At the negative direction of the coil current resulting field decreases and MMA element contracts. Pre-stress force can be generated in same a way as in Example 2 due the proper location of the permanent magnet 3a.

### Example 20

This example is presented in FIG. 20. In the case of high forces and low strokes, device can be built by assembling the modules presented in FIG. 20. Operation principle is the same as in Example 2, only topology is different.

### Example 21

This example is presented in FIG. 21. The solution is well applicable for cases when high force and small stroke are necessary. All MMA elements 1 are in one row and pre-stress is generated by the magnetic draft force that arises when a part of the bias field is conducted through the ferromagnetic body 7.

### Example 22

This example is presented in FIG. 22. Here, in the same way as in Example 4, the aim is to eliminate the spring. For this purpose, we use auxiliary body (organ) 7 that rotates around the axis 8. When MMA element 1a extends, it compresses MMA element 1b and vice versa.

As we see in FIG. 22, the bias fields generated by the permanent magnets 3a and 3b are inside of MMA elements 1a and 1b in the opposite directions. The field directions generated by coils 2a and 2b have the same directions. Thus, for the situation presented in FIG. 22, the field in MMA element 1b increases and in 1a decreases. Owing to that fact, the extension force in MMA element 1b is higher than in 1a. As a result, MMA element 1b extends, it rotates lever 7 and compresses element 1b. When we change the direcion of the currents in the coils, the situation will be vice versa.

### Example 23

The device structure is presented in FIG. 23. This device can produce reversible motion (force) without a pre-stressforce. Therefore, the spring is not necessary and this improves the performance of the device. Device contains two MMA elements 1a and 1b that are supported by the end body 6a and 6b from the opposite ends. Coils 2a and 2b are placed in the outer magnetic circuit part 4a. Output shaft 7 is placed in the central hole of the magnetic circuit part 4b. The shaft touches opposite ends of the MMA elements 1a and 1b. Permanent magnets 3a and 3b generates the bias fields inside MMA elements 1a and 1b and the magnetic circuit. The paths of the bias field are shown in FIG. 23 by dashed lines. Magnetomotive forces of coils 1a and 1b presented by the arrows have the same directions.

Device operates according to the following principle. When currents in coils are missing the MMA elements are biased with magnetic field that has the same value. As a result, MMA elements try to move the shaft 7 in opposite directions with equal force. Therefore, shaft 7 has neutral position, because the resulting force is zero.

When we apply current and generate additional magnetic field with the direction given in FIG. 23, the field in MMA element 1b increases and in the element 1a decreases. Therefore, the force produced by MMA element 1b becomes higher and the force produced by MMA element 1a becomes lower, and shaft 7 shifts up. When we change the direction of the current, the situation will be opposite and shaft 7 moves down.

### Example 24

The device structure is presented in FIG. 24. Main disadvantage of the device in Example 23 is a bending torque that can arise due the unsymmetrical shaft structure. Therefore, in FIG. 24, the device contains four MMA elements 1a, 1b, 1c and 1d and they are located symmetrically around the shaft 7 in order that simultaneously either two MMA elements 1a and 1c or two MMA elements 1b and 1d extend. Double number of the MMA elements is main difference of this solution in comparison with Example 23.

Device operates according to the following principle. When currents in coils are missing, the MMA elements are biased with magnetic field that has the same value. As a result, MMA elements try to move the shaft 7 in opposite directions with equal force. Therefore, shaft 7 has neutral position because the resulting force is zero.

When we apply current and generate additional magnetic field with the direction given in FIG. 24, the fields in MMA elements 1b and 1d increase and in elements 1a and 1c decrease. Therefore, the force produced by MMA elements 1b and 1d becomes higher and by MMA elements 1a and 1c lower, and the shaft 7 shifts down. When we change the direction of the currents, the situation will be opposite and the shaft 7 moves up.

Because of the symmetrical location of MMA elements and the shaft structure, the bending torque is missing, which improves the dynamic and static performance of the device.

### Example 25

The device structure is presented in FIG. 25a. Main difference of this device in comparison with Example 24 is that permanent magnets 3a and 3b are placed inside of the magnetic circuit 4. This improvement fixes the air gap, in which MMA elements are located, and makes it more stable mechanically. In FIG. 25b, one measurement result is presented for such a type of the MMA device. As is seen in the figure, the displacement depends on the coil current, and this characteristic has hysteresis. It is also seen that the device can keep its position at the zero value of the coil current. Thus, in many applications the position remains without the power consumptio and the power is necessary only hen we change the position.

### Example 26

The device structure is presented in FIG. 26a. It has similar structure as in Example 1, and it operates in the same way, but permanent magnets that have created the bias field are removed. Therefore, only the coil currents produce the magnetic field in the splitted MMA element parts 1a and 1b. In addition, the parts of the magnetic circuit 4a, 4b and 4c can join into the units (modules) that are convenient to manufacture.

In the case when biasing is necessary to achieve the hysteresis, magnetic core parts can be manufactured fom the ferromagnetic material with the high coercive force.

In FIG. 26b, the same device is presented, but it has shaft 7 that passes through the device. Therefore, the MMA device has two outputs. One of them can be used, for example, for the position sensor and the second one to produce work. Owing to the through going shaft we also can assemble many MSM devices together to super impose the forces of each device. In this way, it is possible to reduce cross-section area of the device to achieve a big force. This is important in many applications where cross-sectional space is restricted. In addition, it is possible to reduce total mass and losses of the MMA device, by combining the magnetic circuits and the coils of the separate actuators. This through going shaft principle can also be applied for all other Examples of the MMA devices presented before and later.

In the same manner we can assemble the actuators that produce forces in opposite directions, then external pre-stress force source is not necessary and we receive the reversible motion. Opposite directed actuators are energized by turns.

### Example 27

The device structure is presented in FIG. 27. It has similar structure as in Example 2, operates in the same way, bid permanent magnets that create the bias field are removed. Therefore, only the coil currents produce the magnetic field in the MMA element.

### Example 28

The device structure is presented in FIG. 28. It has similar structure as in Example 3, operates in the same way, but permanent magnets that create the bias field are removed. Therefore, only the coil currents produce the magnetic field in the MMA element.

### Example 29

The device structure is presented in FIG. 29. It has similar structure as in Example 8, operates in the same way, but permanent magnets that create the bias field are removed. Therefore, only the coil currents produce the magnetic field in the MMA element.

### Example 30

The device structure is presented in FIG. 30. It has similar structure as in Example 9, operates in the same way, but permanent magnets that create the bias field are removed. Therefore, only the coil currents produce the magnetic field in the MMA element.

### Example 31

The device structure is presented in FIGS. 31a and 31b. It has similar structure as in Example 11, operates the same way, but permanent magnets that create the bias field are removed. Therefore, only the coil currents produce the magnetic field in the MMA element.

### Example 32

The device structure is presented in FIGS. 32. It has similar structure as in Example 12, operates in the same way, but permanent magnets that create the bias field are removed. Therefore, only the coil currents produce the magnetic field in the MMA element.

### Example 33

The device structure is presented in FIGS. 33. It has similar structure as in Example 14, operates in the same way, but permanent magnets that create the bias field are removed. Therefore, only the coil currents produce the magnetic field in the MMA element.

### Example 34

The device structure is presented in FIGS. 34. It has similar structure as in Example 17, operates in the same way, but permanent magnets that create the bias field are removed. Therefore, only the coil currents produce the magnetic field in the MMA element.

### Example 35

The device structure is presented in FIGS. 35a, 35b and 35c. It has similar structure as in Example 18, operates in the same way, but permanent magnets that create the bias field are removed. Therefore, only the coil currents produce the magnetic field in the MMA element.

### Example 36

The device structure is presented in FIGS. 36a, 36b and 36c. It has similar structure as in Example 19, operates in the same way, but permanent magnets that create the bias field are removed. Therefore, only the coil currents produce the magnetic field in the MMA elemnent. In addition, FIG. 36c presents the case when we use through going shaft 7b that pre-stresses the MMA elements by body 7a with pre-stress spring 5.

### Example 37

The device structure is presented in FIG. 37. It has similar structure as in Example 20, operates in the same way, but permanent magnets that create the bias field are removed. Dashed line plots the path of the field produced by the coil currents.

### Example 38

The device structure is presented in FIG. 38. It has similar structure as in Example 21, operates in the same way, but permanent magnets that create the bias field are removed.

### Example 39

The device structure is presented in FIG. 39. It has similar structure as in Examples 22 and 23, but permanent magnets that create the bias field are removed. Therefore, to achieve reversible motion of the shaft 7 and by turns operation of the MMA elements 1a and 1b the coils 2a and 2b are energized by turns. Dashed lines show the paths of the magnetic fields produced by the coils.

### Example 40

The device structure is presented in FIGS. 40. It has similar structure as in Examples 25, but permanent magnets that create the bias field are removed. Therefore, to achieve reversible motion of the shaft 7 and by turns operation of the MMA element pairs 1a-1c and 1b-1d, the coils 2a and 2b are energized at the same time, but in one pair of the them (2b or 2c-2d) the direction of the current changes by turns. Dashed lines show the paths of the magnetic fields produced by the coils.

1. An apparatus comprising an active element which is made from a material having variants separated by a twin boundary or by an interface between austenite and martensite phases or the material being magnetostrictive, wherein a shape of the active element is coupled to an external magnetic field a device for producing on the element forces that affect a shape change thereof, a device for controlling vibrations thereon, a device for generating electric power, a device for changing stiffness of a structure, combinations thereof.

2. An apparatus according to claim 1, wherein the device is comprises at least one active element and at least one magnetic field source.

3. An apparatus according to claim 1, wherein the device comprises at least one of an active element, an electromagnet and a bias magnet.

4. An apparatus according to claim 1, wherein the device comprises at least one active element, at least one electromagnet and at least one bias magnet, wherein the at least one bias magnet is located in the device in such position to produce a magnetic field in the active element, and at the same time, an internal alternating magnetic field produced by the electromagnet and demagnetization thereof is minimized, whereby a demagnetization field strength produced by the electromagnet is lower than the coercive force of the at least one bias magnet.

5. An apparatus according to claim 1, wherein the device is a microdevice.

6. An apparatus according to claim 1, wherein the material of the active element is a Heusler alloy.

7. An apparatus according to claim 1, wherein the material of the active element is a Co-, Ni-, Mn-, or Fe-based alloy.

8. An apparatus according to claim 1, wherein the material of the active element is initially single crystalline, textured polycrystalline or randomly oriented polycrystalline material.

9. An apparatus according to claim 1, wherein the shape change of the active element is extension and/or contraction.

10. An apparatus according to claim 1, wherein the shape change of the active element is bending.

11. An apparatus according to claim 1, wherein the active element is a thin film.

12. An apparatus according to claim 1, wherein the active element is composed of at least two parts that are fixed together with an elastomer.

13. An apparatus according to claim 1, wherein the active element is a composite structure including MMA material particles, fibers or plates in an elastic matrix.

14. An apparatus according to claim 12, wherein the elastomer acts as a bias spring to restore original dimensions of the active element.

15. An apparatus according to claim 1, further comprising a yoke defining a magnetic flux path.

16. An apparatus according to claim 15, wherein the yoke is made from a high permeability ferromagnetic material.

17. An apparatus according to claim 15, wherein the material of the yoke is made from a ferromagnetic material that exhibits high coercitive force.

18. An apparatus according to claim 15, wherein the yoke comprises separate parts.

19. An apparatus according to claim 18, wherein the separate parts of the yoke exhibit different magnetic properties.

20. An apparatus according to claim 15, wherein the yoke works as a whole or partly as a bias magnet or has a separate part working as a bias magnet.

21. An apparatus according to claim 15, wherein a carbon content of the yoke is varying along the yoke.

22. An apparatus according to claim 15, wherein the yoke comprises electrically insulated sheets of a ferromagnetic material to reduce eddy current losses caused by an alternating magnetic field.

23. An apparatus according to claim 15, wherein the yoke is made from a composite including ferromagnetic particles in an electrically insulating matrix or a polymer.

24. An apparatus according to claim 3, wherein the bias magnet is constructed of a Fe—Bo—Nd, Co—Sm, Al—Ni—Co, or Co-based alloy.

25. An apparatus according to claim3, wherein the bias magnet is located outside of physical dimensions of the electromagnet centrally relative to the electromaqnet.

26. (canceled)

27. An apparatus according to claim 1, further comprising a mechanical or electrical device for returning the active element to an original size/position.

28. An apparatus according to claim 1, comprising an active element, two coils, two permanent magnets, a yoke and a mechanical or electrical device for returning the active element to an original size/position.

29. An apparatus according to claim 1, wherein the magnetic field is applied in short pulses.

30. An apparatus according to claim 29, wherein pulses generated by a first electromagnet extends the active element, and pulses generated by the second electromagnet, a field of which being substantially perpendicular to field of the first electromagnet, contracts the active element.

31. An apparatus according to claim 3, wherein the apparatus has an unsymmetrical construction, wherein one electromagnet and one bias magnet are located on a same side of the active element.

32. An apparatus according to claim 1, comprising several apparatuses according to claim 1 in a row-like or ring like construction.

33. An apparatus according to claim 1, comprising two active elements designed to move a rodlike element in opposite directions.

34. An apparatus according to claim 32, wherein the construction increases a force of the apparatus.

35. An apparatus according to claim 33, wherein the active elements are counter working active elements.

36. An apparatus according to claim 30, further comprising at least a second active element working against the active element for stiffening purposes.

37. A vibration damping device according to claim 1, comprising at least one active element and at least one bias magnet whose magnetic field is perpendicular to a loading direction of the element.

38-81. (canceled)

82 (canceled)

83 (canceled)

84. An apparatus according to claim 18, wherein an outermost part is made from a high coercive material to act as a bias magnet.
